(19) United States
(12) Patent Application Publication
(10) Pub. No.: US 2014/0229741 A1
(43) Pub. Date: Aug. 14, 2014

(54) Dual Composite Field Advanced Encryption Standard Memory Encryption Engine

(71) Applicants: Sanu K. Mathew, Hillsboro, OR (US); Shay Gueron, Haifa (IL); Ram K. Krishnamurthy, Portland, OR (US)

(72) Inventors: Sanu K. Mathew, Hillsboro, OR (US); Shay Gueron, Haifa (IL); Ram K. Krishnamurthy, Portland, OR (US)

(21) Appl. No.: 13/993,545

(22) PCT Filed: Dec. 30, 2011
(86) PCT No.: PCT/US11/68003

§ 371 Date: Apr. 22, 2014

(51) Int. Cl. G06F 21/72; G06F 21/60

(52) U.S. Cl. CPC G06F 21/72; G06F 21/60
USPC 713/189

(57) ABSTRACT

A different set of polynomials may be selected for encryption and decryption accelerators. That is, different sets of polynomials are used for encryption and decryption, each set being chosen to use less area and deliver more power for a memory encryption engine. This is advantageous in some embodiments since memory read operations are typically more critical and latency sensitive than memory writes.

### BACKGROUND

This relates generally to a memory encryption engine.

A memory encryption engine is used to protect data as it is written to and read from memory. Typically the encryption uses the Advanced Encryption Standard (AES). See NIST Advanced Encryption Standard (FIP pub. 197, Nov. 26, 2001). The Advanced Encryption Standard is a symmetric-key encryption protocol used to encrypt and decrypt all read and write memory accesses. In order to prevent reads and writes from swamping processor performance, hardware accelerated AES encrypt and decrypt operations are desirable.

AES provides several modes of operations. AES-128, AES-192 and AES-256 modes of operation submit 128-bit input data to respectfully, ten, twelve, and fourteen iterations of an AES round operation. The AES round operation includes successive Substitute Bytes, ShiftRow and MixedColumns transformations, followed by an AddRoundKey operation.

During the Substitute Bytes transformation, each 8-bits of the 128-bit input data is input into one of sixteen S-boxes. Each S-box computes the multiplicative inverse of its respective 8-bit input in the Galois Field GF(2⁸). Some implementations map the 8-bit input to a composite field, (GF(2⁴)²), compute the multiplicative inverse in GF(2⁴)², map the result back to a ground field GF(2⁸), and proceed to the shift row transformation.

### BRIEF DESCRIPTION OF THE DRAWINGS

Some embodiments are described with respect to the following figures:

FIG. 1 is a schematic depiction of a memory encryption engine;

FIG. 2 is an advanced encryption standard S-box according to one embodiment;

FIG. 3 is a depiction of the multiplier equations according to one embodiment to the present invention;

FIG. 4 is a depiction of the GF(2⁴) multiplier according to one embodiment;

FIG. 5 is a depiction of an S-box subblock for encrypt and decrypt according to one embodiment;

FIG. 6 is a depiction of an S-box subblock for encrypt and decrypt according to another embodiment;

FIG. 7 is a schematic depiction of MixColumn block for encrypt according to one embodiment;

FIG. 8 is a flow chart for one embodiment; and

FIG. 9 is a system depiction for one embodiment.

### DETAILED DESCRIPTION

In accordance with some embodiments, different sets of polynomials are selected for encryption and decryption accelerators. That is, different sets of polynomials are used for encryption and decryption, each set being chosen to use less area and deliver more power for a memory encryption engine. This is advantageous in some embodiments since memory read operations are typically more critical and latency sensitive than memory writes.

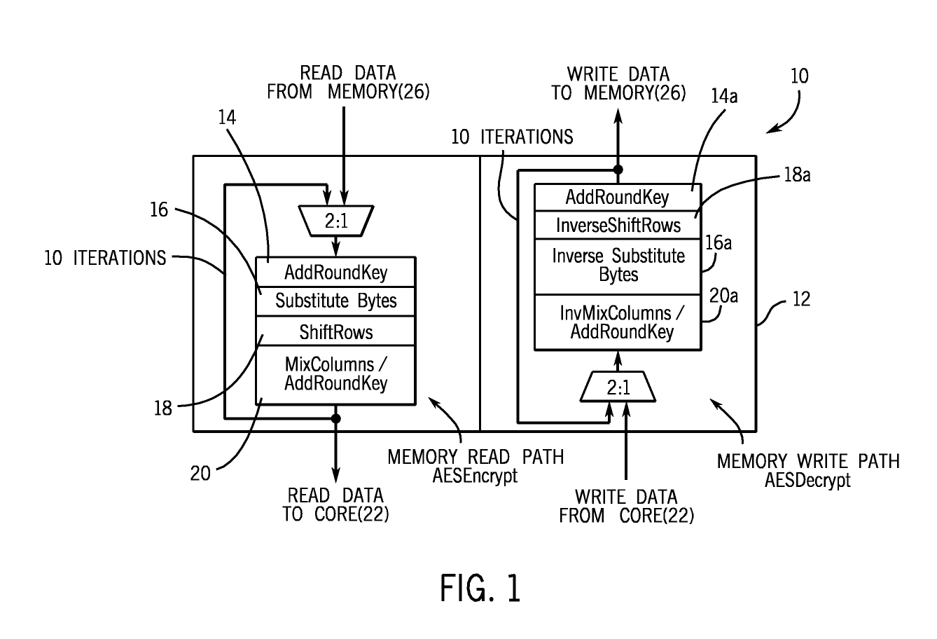

Referring to FIG. 1, read data from memory 26 is provided to a two to one multiplexer in a memory encryption engine 10 and then to an AddRoundKey unit 14 in the memory read path. From there the data goes to a Substitute Bytes block 16, ShiftRows block 18 and MixColumns/AddRoundKey block 20. After ten iterations, according to one embodiment, the read data from the core 22 is output. The core 22 may be a processor such as a central processing unit.

Work data from the core 22 is provided to a two to one multiplexer in the memory write path and then to an inverse MixColumn/AddRoundKey unit 20a. From here the data goes to an inverse Substitute Bytes unit 16a and an InverseShiftRows unit 18a. Finally the data is outputted from an AddRoundKey unit 14a of write data to memory 26 after ten iterations, according to one embodiment.

In some embodiments, a trade-off is made to improve a read path by using simpler computations of AES-128 encrypt during a memory read, while using AES-128 decrypt during memory writes. This avoids using more complex AES-128 decrypt memory reads. The presence of a larger number of read ports compared to write ports also makes this trade-off attractive from a silicon area use perspective.

The use of separate encrypt and decrypt hardware for simultaneous read and write operations makes the use of the same set of polynomials for both encrypt and decrypt suboptimal. Thus some embodiments use two sets of polynomials: one for encrypt and the other for decrypt.

To facilitate inverse computation in the Substitute Bytes, the plaintext operands in GF(2⁸) are mapped to the composite-field of GF(2⁴)². The corresponding two-term element in the composite field is represented as shx+sl, where the elements sh and sl are terms in the field of GF(2⁴) and the composite-field is defined by the polynomial x²+αx+β. Operations in the ground field of GF(2⁴) are, on the other hand, defined by a ground-field polynomial. There are sixteen potential choices for the ground-field polynomial of order four, ranging from x⁴, x⁴+1 . . . x⁴+x³+x²+x+1. The ground-field polynomial is a polynomial that is irreducible over GF(2), i.e. it does not have a root in GF(2)={0,1}. This requirement eliminates most choices, leaving x⁴+x+1, x⁴+x³+1 and x⁴+x³+x²+x+1 as potential ground-field polynomials.

The composite-field GF(2⁴)² is an extension of the ground field GF(2⁴). It is therefore associated with a generator polynomial known as the composite-field polynomial x²+αx+β, where α and β are elements of GF(2⁴). In some embodiments the polynomial may be irreducible (i.e. not have a root) in GF(2⁴). There are 256 potential candidates for the composite-field polynomial, ranging from x², x²+1, . . . x²+Fx+E, x²+Fx+F. The list of 4096 possible combinations of ground and composite-field polynomials is pruned down to 360 combinations by the test for irreducibility. The next step involves the search for an element ‘e’ in GF(2⁴)² that is both a root of the composite-field (i.e e²+αe+β=0) and has some power ‘y’ that is also a root of the original GF(2⁸) generator polynomial (i.e. (e^{y})⁸+(e^{y})⁴+(e^{y})³+(e^{y})+1=0). The element e^{y} forms the basis of the composite-field. The above tests yields eight potential bases in each of the 360 combinations, leading to 2880 valid representations for the composite-field.

Ground-Field Poly = x⁴ + x + 1

| C-F poly | Basis | C-F poly | Basis | C-F poly | Basis | C-F poly | Basis | C-F poly | Basis | C-F poly | Basis | C-F poly | Basis | C-F poly | Basis |
|---|---|---|---|---|---|---|---|---|---|---|---|---|---|---|---|
| x² + 1x + 8 | 20 | x² + 2x + 1 | 1D | x² + 3x + 1 | 18 | x² + 4x + 1 | 1A | x² + 5x + 1 | 19 | x² + 6x + 2 | 8A | x² + 7x + 2 | A9 | x² + 8x + 1 | 21 |
| x² + 1x + 8 | 22 | x² + 2x + 1 | 1F | x² + 3x + 1 | 1B | x² + 4x + 1 | 1E | x² + 5x + 1 | 1C | x² + 6x + 2 | 8F | x² + 7x + 2 | AA | x² + 8x + 1 | 22 |
| x² + 1x + 8 | 3C | x² + 2x + 1 | 2B | x² + 3x + 1 | 38 | x² + 4x + 1 | 49 | x² + 5x + 1 | 5C | x² + 6x + 2 | 94 | x² + 7x + 2 | BA | x² + 8x + 1 | 60 |
| x² + 1x + 8 | 3F | x² + 2x + 1 | 2F | x² + 3x + 1 | 3D | x² + 4x + 1 | 4A | x² + 5x + 1 | 5E | x² + 6x + 2 | 97 | x² + 7x + 2 | BE | x² + 8x + 1 | 65 |
| x² + 1x + 8 | 42 | x² + 2x + 1 | 8D | x² + 3x + 1 | D3 | x² + 4x + 1 | 94 | x² + 5x + 1 | A9 | x² + 6x + 2 | E1 | x² + 7x + 2 | C4 | x² + 8x + 1 | 98 |
| x² + 1x + 8 | 46 | x² + 2x + 1 | 8E | x² + 3x + 1 | D7 | x² + 4x + 1 | 96 | x² + 5x + 1 | AD | x² + 6x + 2 | E3 | x² + 7x + 2 | C6 | x² + 8x + 1 | 9C |
| x² + 1x + 8 | 51 | x² + 2x + 1 | B2 | x² + 3x + 1 | F9 | x² + 4x + 1 | CB | x² + 5x + 1 | E5 | x² + 6x + 2 | F0 | x² + 7x + 2 | DB | x² + 8x + 1 | D5 |
| x² + 1x + 8 | 54 | x² + 2x + 1 | B7 | x² + 3x + 1 | FB | x² + 4x + 1 | CE | x² + 5x + 1 | E6 | x² + 6x + 2 | F4 | x² + 7x + 2 | DE | x² + 8x + 1 | D7 |
| x² + 1x + 9 | 2C | x² + 2x + 2 | 1C | x² + 3x + 3 | 19 | x² + 4x + 2 | 11 | x² + 5x + 3 | 11 | x² + 6x + 3 | 80 | x² + 7x + 3 | A5 | x² + 8x + 3 | 2D |
| x² + 1x + 9 | 2E | x² + 2x + 2 | 1E | x² + 3x + 3 | 1A | x² + 4x + 2 | 15 | x² + 5x + 3 | 14 | x² + 6x + 3 | 85 | x² + 7x + 3 | A6 | x² + 8x + 3 | 2E |
| x² + 1x + 9 | 35 | x² + 2x + 2 | 29 | x² + 3x + 3 | 3B | x² + 4x + 2 | 40 | x² + 5x + 3 | 50 | x² + 6x + 3 | 91 | x² + 7x + 3 | B9 | x² + 8x + 3 | 62 |
| x² + 1x + 9 | 36 | x² + 2x + 2 | 2D | x² + 3x + 3 | 3E | x² + 4x + 2 | 43 | x² + 5x + 3 | 52 | x² + 6x + 3 | 92 | x² + 7x + 3 | BD | x² + 8x + 3 | 67 |
| x² + 1x + 9 | 49 | x² + 2x + 2 | 85 | x² + 3x + 3 | DA | x² + 4x + 2 | 98 | x² + 5x + 3 | A2 | x² + 6x + 3 | E5 | x² + 7x + 3 | CC | x² + 8x + 3 | 9B |
| x² + 1x + 9 | 4D | x² + 2x + 2 | 86 | x² + 3x + 3 | DE | x² + 4x + 2 | 9A | x² + 5x + 3 | A6 | x² + 6x + 3 | E7 | x² + 7x + 3 | CE | x² + 8x + 3 | 9F |
| x² + 1x + 9 | 59 | x² + 2x + 2 | B9 | x² + 3x + 3 | F4 | x² + 4x + 2 | C3 | x² + 5x + 3 | EC | x² + 6x + 3 | F8 | x² + 7x + 3 | D9 | x² + 8x + 3 | DD |
| x² + 1x + 9 | 5C | x² + 2x + 2 | BC | x² + 3x + 3 | F6 | x² + 4x + 2 | C6 | x² + 5x + 3 | EF | x² + 6x + 3 | FC | x² + 7x + 3 | DC | x² + 8x + 3 | DF |
| x² + 1x + A | 25 | x² + 2x + 5 | 11 | x² + 3x + 4 | 11 | x² + 4x + 4 | 1B | x² + 5x + 5 | 18 | x² + 6x + 4 | 88 | x² + 7x + 4 | A0 | x² + 8x + 4 | 29 |
| x² + 1x + A | 27 | x² + 2x + 5 | 13 | x² + 3x + 4 | 12 | x² + 4x + 4 | 1F | x² + 5x + 5 | 1D | x² + 6x + 4 | 8D | x² + 7x + 4 | A3 | x² + 8x + 4 | 2A |
| x² + 1x + A | 31 | x² + 2x + 5 | 20 | x² + 3x + 4 | 30 | x² + 4x + 4 | 4D | x² + 5x + 5 | 59 | x² + 6x + 4 | 98 | x² + 7x + 4 | B1 | x² + 8x + 4 | 6B |
| x² + 1x + A | 32 | x² + 2x + 5 | 24 | x² + 3x + 4 | 35 | x² + 4x + 4 | 4E | x² + 5x + 5 | 5B | x² + 6x + 4 | 9B | x² + 7x + 4 | B5 | x² + 8x + 4 | 6E |
| x² + 1x + A | 48 | x² + 2x + 5 | 84 | x² + 3x + 4 | D8 | x² + 4x + 4 | 9D | x² + 5x + 5 | A3 | x² + 6x + 4 | E9 | x² + 7x + 4 | C8 | x² + 8x + 4 | 9A |
| x² + 1x + A | 4C | x² + 2x + 5 | 87 | x² + 3x + 4 | DC | x² + 4x + 4 | 9F | x² + 5x + 5 | A7 | x² + 6x + 4 | EB | x² + 7x + 4 | CA | x² + 8x + 4 | 9E |
| x² + 1x + A | 50 | x² + 2x + 5 | BA | x² + 3x + 4 | F5 | x² + 4x + 4 | C2 | x² + 5x + 5 | E8 | x² + 6x + 4 | F3 | x² + 7x + 4 | D3 | x² + 8x + 4 | D4 |
| x² + 1x + A | 55 | x² + 2x + 5 | BF | x² + 3x + 4 | F7 | x² + 4x + 4 | C7 | x² + 5x + 5 | EB | x² + 6x + 4 | F7 | x² + 7x + 4 | D6 | x² + 8x + 4 | D6 |
| x² + 1x + B | 29 | x² + 2x + 6 | 10 | x² + 3x + 6 | 10 | x² + 4x + 7 | 10 | x² + 5x + 7 | 10 | x² + 6x + 5 | 82 | x² + 7x + 5 | AC | x² + 8x + 6 | 25 |
| x² + 1x + B | 2B | x² + 2x + 6 | 12 | x² + 3x + 6 | 13 | x² + 4x + 7 | 14 | x² + 5x + 7 | 15 | x² + 6x + 5 | 87 | x² + 7x + 5 | AF | x² + 8x + 6 | 26 |
| x² + 1x + B | 38 | x² + 2x + 6 | 22 | x² + 3x + 6 | 33 | x² + 4x + 7 | 44 | x² + 5x + 7 | 55 | x² + 6x + 5 | 9D | x² + 7x + 5 | B2 | x² + 8x + 6 | 69 |
| x² + 1x + B | 3B | x² + 2x + 6 | 26 | x² + 3x + 6 | 36 | x² + 4x + 7 | 47 | x² + 5x + 7 | 57 | x² + 6x + 5 | 9E | x² + 7x + 5 | B6 | x² + 8x + 6 | 6C |
| x² + 1x + B | 43 | x² + 2x + 6 | 8C | x² + 3x + 6 | D1 | x² + 4x + 7 | 91 | x² + 5x + 7 | A8 | x² + 6x + 5 | ED | x² + 7x + 5 | C0 | x² + 8x + 6 | 99 |
| x² + 1x + B | 47 | x² + 2x + 6 | 8F | x² + 3x + 6 | D5 | x² + 4x + 7 | 93 | x² + 5x + 7 | AC | x² + 6x + 5 | EF | x² + 7x + 5 | C2 | x² + 8x + 6 | 9D |
| x² + 1x + B | 58 | x² + 2x + 6 | B1 | x² + 3x + 6 | F8 | x² + 4x + 7 | CA | x² + 5x + 7 | E1 | x² + 6x + 5 | FB | x² + 7x + 5 | D1 | x² + 8x + 6 | DC |
| x² + 1x + B | 5D | x² + 2x + 6 | B4 | x² + 3x + 6 | FA | x² + 4x + 7 | CF | x² + 5x + 7 | E2 | x² + 6x + 5 | FF | x² + 7x + 5 | D4 | x² + 8x + 6 | DE |
| x² + 1x + C | 21 | x² + 2x + 9 | 18 | x² + 3x + 9 | 14 | x² + 4x + 8 | 19 | x² + 5x + 9 | 12 | x² + 6x + A | 89 | x² + 7x + 8 | AD | x² + 8x + 8 | 20 |
| x² + 1x + C | 23 | x² + 2x + 9 | 1A | x² + 3x + 9 | 17 | x² + 4x + 8 | 1D | x² + 5x + 9 | 17 | x² + 6x + A | 8C | x² + 7x + 8 | AE | x² + 8x + 8 | 23 |
| x² + 1x + C | 34 | x² + 2x + 9 | 21 | x² + 3x + 9 | 3A | x² + 4x + 8 | 45 | x² + 5x + 9 | 5D | x² + 6x + A | 95 | x² + 7x + 8 | BB | x² + 8x + 8 | 63 |
| x² + 1x + C | 37 | x² + 2x + 9 | 25 | x² + 3x + 9 | 3F | x² + 4x + 8 | 46 | x² + 5x + 9 | 5F | x² + 6x + A | 96 | x² + 7x + 8 | BF | x² + 8x + 8 | 66 |
| x² + 1x + C | 40 | x² + 2x + 9 | 80 | x² + 3x + 9 | D0 | x² + 4x + 8 | 9C | x² + 5x + 9 | AB | x² + 6x + A | EC | x² + 7x + 8 | CD | x² + 8x + 8 | 91 |
| x² + 1x + C | 44 | x² + 2x + 9 | 83 | x² + 3x + 9 | D4 | x² + 4x + 8 | 9E | x² + 5x + 9 | AF | x² + 6x + A | EE | x² + 7x + 8 | CF | x² + 8x + 8 | 95 |
| x² + 1x + C | 5A | x² + 2x + 9 | B3 | x² + 3x + 9 | F1 | x² + 4x + 8 | C9 | x² + 5x + 9 | ED | x² + 6x + A | F9 | x² + 7x + 8 | D2 | x² + 8x + 8 | D8 |
| x² + 1x + C | 5F | x² + 2x + 9 | B6 | x² + 3x + 9 | F3 | x² + 4x + 8 | CC | x² + 5x + 9 | EE | x² + 6x + A | FD | x² + 7x + 8 | D7 | x² + 8x + 8 | DA |
| x² + 1x + D | 2D | x² + 2x + A | 19 | x² + 3x + B | 15 | x² + 4x + B | 12 | x² + 5x + B | 1A | x² + 6x + B | 83 | x² + 7x + 9 | A1 | x² + 8x + A | 2C |
| x² + 1x + D | 2F | x² + 2x + A | 1B | x² + 3x + B | 16 | x² + 4x + B | 16 | x² + 5x + B | 1F | x² + 6x + B | 86 | x² + 7x + 9 | A2 | x² + 8x + A | 2F |
| x² + 1x + D | 3D | x² + 2x + A | 23 | x² + 3x + B | 39 | x² + 4x + B | 4C | x² + 5x + B | 51 | x² + 6x + B | 90 | x² + 7x + 9 | B8 | x² + 8x + A | 61 |
| x² + 1x + D | 3E | x² + 2x + A | 27 | x² + 3x + B | 3C | x² + 4x + B | 4F | x² + 5x + B | 53 | x² + 6x + B | 93 | x² + 7x + 9 | BC | x² + 8x + A | 64 |
| x² + 1x + D | 4B | x² + 2x + A | 88 | x² + 3x + B | D9 | x² + 4x + B | 90 | x² + 5x + B | A0 | x² + 6x + B | E8 | x² + 7x + 9 | C5 | x² + 8x + A | 92 |
| x² + 1x + D | 4F | x² + 2x + A | 8B | x² + 3x + B | DD | x² + 4x + B | 92 | x² + 5x + B | A4 | x² + 6x + B | EA | x² + 7x + 9 | C7 | x² + 8x + A | 96 |
| x² + 1x + D | 52 | x² + 2x + A | B8 | x² + 3x + B | FC | x² + 4x + B | C1 | x² + 5x + B | E4 | x² + 6x + B | F1 | x² + 7x + 9 | D0 | x² + 8x + A | D0 |
| x² + 1x + D | 57 | x² + 2x + A | BD | x² + 3x + B | FE | x² + 4x + B | C4 | x² + 5x + B | E7 | x² + 6x + B | F5 | x² + 7x + 9 | D5 | x² + 8x + A | D2 |
| x² + 1x + E | 24 | x² + 2x + D | 14 | x² + 3x + C | 1D | x² + 4x + D | 18 | x² + 5x + D | 13 | x² + 6x + C | 8B | x² + 7x + E | A4 | x² + 8x + D | 28 |
| x² + 1x + E | 26 | x² + 2x + D | 16 | x² + 3x + C | 1E | x² + 4x + D | 1C | x² + 5x + D | 16 | x² + 6x + C | 8E | x² + 7x + E | A7 | x² + 8x + D | 2B |
| x² + 1x + E | 39 | x² + 2x + D | 2A | x² + 3x + C | 32 | x² + 4x + D | 41 | x² + 5x + D | 58 | x² + 6x + C | 99 | x² + 7x + E | B0 | x² + 8x + D | 68 |
| x² + 1x + E | 3A | x² + 2x + D | 2E | x² + 3x + C | 37 | x² + 4x + D | 42 | x² + 5x + D | 5A | x² + 6x + C | 9A | x² + 7x + E | B4 | x² + 8x + D | 6D |
| x² + 1x + E | 4A | x² + 2x + D | 89 | x² + 3x + C | DB | x² + 4x + D | 95 | x² + 5x + D | A1 | x² + 6x + C | E4 | x² + 7x + E | C1 | x² + 8x + D | 93 |
| x² + 1x + E | 4E | x² + 2x + D | 8A | x² + 3x + C | DF | x² + 4x + D | 97 | x² + 5x + D | A5 | x² + 6x + C | E6 | x² + 7x + E | C3 | x² + 8x + D | 97 |
| x² + 1x + E | 5B | x² + 2x + D | BB | x² + 3x + C | FD | x² + 4x + D | C0 | x² + 5x + D | E0 | x² + 6x + C | FA | x² + 7x + E | DA | x² + 8x + D | D9 |
| x² + 1x + E | 5E | x² + 2x + D | BE | x² + 3x + C | FF | x² + 4x + D | C5 | x² + 5x + D | E3 | x² + 6x + C | FE | x² + 7x + E | DF | x² + 8x + D | DB |
| x² + 1x + F | 28 | x² + 2x + E | 15 | x² + 3x + E | 1C | x² + 4x + E | 13 | x² + 5x + F | 1B | x² + 6x + D | 81 | x² + 7x + F | A8 | x² + 8x + F | 24 |
| x² + 1x + F | 2A | x² + 2x + E | 17 | x² + 3x + E | 1F | x² + 4x + E | 17 | x² + 5x + F | 1E | x² + 6x + D | 84 | x² + 7x + F | AB | x² + 8x + F | 27 |
| x² + 1x + F | 30 | x² + 2x + E | 28 | x² + 3x + E | 31 | x² + 4x + E | 48 | x² + 5x + F | 54 | x² + 6x + D | 9C | x² + 7x + F | B3 | x² + 8x + F | 6A |
| x² + 1x + F | 33 | x² + 2x + E | 2C | x² + 3x + E | 34 | x² + 4x + E | 4B | x² + 5x + F | 56 | x² + 6x + D | 9F | x² + 7x + F | B7 | x² + 8x + F | 6F |
| x² + 1x + F | 41 | x² + 2x + E | 81 | x² + 3x + E | D2 | x² + 4x + E | 99 | x² + 5x + F | AA | x² + 6x + D | E0 | x² + 7x + F | C9 | x² + 8x + F | 90 |
| x² + 1x + F | 45 | x² + 2x + E | 82 | x² + 3x + E | D6 | x² + 4x + E | 9B | x² + 5x + F | AE | x² + 6x + D | E2 | x² + 7x + F | CB | x² + 8x + F | 94 |
| x² + 1x + F | 53 | x² + 2x + E | B0 | x² + 3x + E | F0 | x² + 4x + E | C8 | x² + 5x + F | E9 | x² + 6x + D | F2 | x² + 7x + F | D8 | x² + 8x + F | D1 |
| x² + 1x + F | 56 | x² + 2x + E | B5 | x² + 3x + E | F2 | x² + 4x + E | CD | x² + 5x + F | EA | x² + 6x + D | F6 | x² + 7x + F | DD | x² + 8x + F | D3 |

Ground-Field Poly = x⁴ + x + 1

| C-F poly | Basis | C-F poly | Basis | C-F poly | Basis | C-F poly | Basis | C-F poly | Basis | C-F poly | Basis | C-F poly | Basis |
|---|---|---|---|---|---|---|---|---|---|---|---|---|---|
| x² + 9x + 2 | 40 | x² + Ax + 1 | 51 | x² + Bx + 4 | 21 | x² + Cx + 1 | 41 | x² + Dx + 4 | 30 | x² + Ex + 2 | 51 | x² + Fx + 1 | 31 |
| x² + 9x + 2 | 42 | x² + Ax + 1 | 55 | x² + Bx + 4 | 24 | x² + Cx + 1 | 44 | x² + Dx + 4 | 34 | x² + Ex + 2 | 52 | x² + Fx + 1 | 33 |
| x² + 9x + 2 | 6C | x² + Ax + 1 | 70 | x² + Bx + 4 | 72 | x² + Cx + 1 | 70 | x² + Dx + 4 | 7A | x² + Ex + 2 | 65 | x² + Fx + 1 | 60 |
| x² + 9x + 2 | 6F | x² + Ax + 1 | 73 | x² + Bx + 4 | 76 | x² + Cx + 1 | 72 | x² + Dx + 4 | 7F | x² + Ex + 2 | 67 | x² + Fx + 1 | 64 |
| x² + 9x + 2 | 82 | x² + Ax + 1 | 93 | x² + Bx + 4 | A0 | x² + Cx + 1 | DC | x² + Dx + 4 | 81 | x² + Ex + 2 | C8 | x² + Fx + 1 | B4 |
| x² + 9x + 2 | 86 | x² + Ax + 1 | 96 | x² + Bx + 4 | A2 | x² + Cx + 1 | DF | x² + Dx + 4 | 83 | x² + Ex + 2 | CC | x² + Fx + 1 | B7 |
| x² + 9x + 2 | A1 | x² + Ax + 1 | B8 | x² + Bx + 4 | FC | x² + Cx + 1 | E2 | x² + Dx + 4 | C4 | x² + Ex + 2 | F0 | x² + Fx + 1 | EA |
| x² + 9x + 2 | A4 | x² + Ax + 1 | BA | x² + Bx + 4 | FF | x² + Cx + 1 | E6 | x² + Dx + 4 | C7 | x² + Ex + 2 | F5 | x² + Fx + 1 | EF |
| x² + 9x + 3 | 41 | x² + Ax + 2 | 5B | x² + Bx + 5 | 20 | x² + Cx + 3 | 48 | x² + Dx + 5 | 31 | x² + Ex + 3 | 50 | x² + Fx + 2 | 39 |
| x² + 9x + 3 | 43 | x² + Ax + 2 | 5F | x² + Bx + 5 | 25 | x² + Cx + 3 | 4D | x² + Dx + 5 | 35 | x² + Ex + 3 | 53 | x² + Fx + 2 | 3B |
| x² + 9x + 3 | 64 | x² + Ax + 2 | 7D | x² + Bx + 5 | 78 | x² + Cx + 3 | 79 | x² + Dx + 5 | 73 | x² + Ex + 3 | 68 | x² + Fx + 2 | 63 |
| x² + 9x + 3 | 67 | x² + Ax + 2 | 7E | x² + Bx + 5 | 7C | x² + Cx + 3 | 7B | x² + Dx + 5 | 76 | x² + Ex + 3 | 6A | x² + Fx + 2 | 67 |
| x² + 9x + 3 | 80 | x² + Ax + 2 | 92 | x² + Bx + 5 | A5 | x² + Cx + 3 | D8 | x² + Dx + 5 | 88 | x² + Ex + 3 | C1 | x² + Fx + 2 | B8 |
| x² + 9x + 3 | 84 | x² + Ax + 2 | 97 | x² + Bx + 5 | A7 | x² + Cx + 3 | DB | x² + Dx + 5 | 8A | x² + Ex + 3 | C5 | x² + Fx + 2 | BB |
| x² + 9x + 3 | AA | x² + Ax + 2 | BD | x² + Bx + 5 | F1 | x² + Cx + 3 | E3 | x² + Dx + 5 | C0 | x² + Ex + 3 | F3 | x² + Fx + 2 | E8 |
| x² + 9x + 3 | AF | x² + Ax + 2 | BF | x² + Bx + 5 | F2 | x² + Cx + 3 | E7 | x² + Dx + 5 | C3 | x² + Ex + 3 | F6 | x² + Fx + 2 | ED |
| x² + 9x + 6 | 49 | x² + Ax + 4 | 59 | x² + Bx + 6 | 2A | x² + Cx + 5 | 4B | x² + Dx + 6 | 38 | x² + Ex + 6 | 5D | x² + Fx + 5 | 3C |
| x² + 9x + 6 | 4B | x² + Ax + 4 | 5D | x² + Bx + 6 | 2F | x² + Cx + 5 | 4E | x² + Dx + 6 | 3C | x² + Ex + 6 | 5E | x² + Fx + 5 | 3E |
| x² + 9x + 6 | 68 | x² + Ax + 4 | 75 | x² + Bx + 6 | 70 | x² + Cx + 5 | 74 | x² + Dx + 6 | 70 | x² + Ex + 6 | 6D | x² + Fx + 5 | 69 |
| x² + 9x + 6 | 6B | x² + Ax + 4 | 76 | x² + Bx + 6 | 74 | x² + Cx + 5 | 76 | x² + Dx + 6 | 75 | x² + Ex + 6 | 6F | x² + Fx + 5 | 6D |
| x² + 9x + 6 | 83 | x² + Ax + 4 | 99 | x² + Bx + 6 | A1 | x² + Cx + 5 | D9 | x² + Dx + 6 | 85 | x² + Ex + 6 | CB | x² + Fx + 5 | B5 |
| x² + 9x + 6 | 87 | x² + Ax + 4 | 9C | x² + Bx + 6 | A3 | x² + Cx + 5 | DA | x² + Dx + 6 | 87 | x² + Ex + 6 | CF | x² + Fx + 5 | B6 |
| x² + 9x + 6 | A8 | x² + Ax + 4 | BC | x² + Bx + 6 | F4 | x² + Cx + 5 | EA | x² + Dx + 6 | C1 | x² + Ex + 6 | F2 | x² + Fx + 5 | E9 |
| x² + 9x + 6 | AD | x² + Ax + 4 | BE | x² + Bx + 6 | F7 | x² + Cx + 5 | EE | x² + Dx + 6 | C2 | x² + Ex + 6 | F7 | x² + Fx + 5 | EC |
| x² + 9x + 7 | 48 | x² + Ax + 7 | 53 | x² + Bx + 7 | 2B | x² + Cx + 7 | 42 | x² + Dx + 7 | 39 | x² + Ex + 7 | 5C | x² + Fx + 6 | 34 |
| x² + 9x + 7 | 4A | x² + Ax + 7 | 57 | x² + Bx + 7 | 2E | x² + Cx + 7 | 47 | x² + Dx + 7 | 3D | x² + Ex + 7 | 5F | x² + Fx + 6 | 36 |
| x² + 9x + 7 | 60 | x² + Ax + 7 | 78 | x² + Bx + 7 | 7A | x² + Cx + 7 | 7D | x² + Dx + 7 | 79 | x² + Ex + 7 | 60 | x² + Fx + 6 | 6A |
| x² + 9x + 7 | 63 | x² + Ax + 7 | 7B | x² + Bx + 7 | 7E | x² + Cx + 7 | 7F | x² + Dx + 7 | 7C | x² + Ex + 7 | 62 | x² + Fx + 6 | 6E |
| x² + 9x + 7 | 81 | x² + Ax + 7 | 98 | x² + Bx + 7 | A4 | x² + Cx + 7 | DD | x² + Dx + 7 | 8C | x² + Ex + 7 | C2 | x² + Fx + 6 | B9 |
| x² + 9x + 7 | 85 | x² + Ax + 7 | 9D | x² + Bx + 7 | A6 | x² + Cx + 7 | DE | x² + Dx + 7 | 8E | x² + Ex + 7 | C6 | x² + Fx + 6 | BA |
| x² + 9x + 7 | A3 | x² + Ax + 7 | B9 | x² + Bx + 7 | F9 | x² + Cx + 7 | EB | x² + Dx + 7 | C5 | x² + Ex + 7 | F1 | x² + Fx + 6 | EB |
| x² + 9x + 7 | A6 | x² + Ax + 7 | BB | x² + Bx + 7 | FA | x² + Cx + 7 | EF | x² + Dx + 7 | C6 | x² + Ex + 7 | F4 | x² + Fx + 6 | EE |
| x² + 9x + A | 44 | x² + Ax + 9 | 5A | x² + Bx + C | 28 | x² + Cx + 8 | 4A | x² + Dx + 8 | 33 | x² + Ex + 8 | 59 | x² + Fx + 8 | 35 |
| x² + 9x + A | 46 | x² + Ax + 9 | 5E | x² + Bx + C | 2D | x² + Cx + 8 | 4F | x² + Dx + 8 | 37 | x² + Ex + 8 | 5A | x² + Fx + 8 | 37 |
| x² + 9x + A | 69 | x² + Ax + 9 | 79 | x² + Bx + C | 73 | x² + Cx + 8 | 71 | x² + Dx + 8 | 78 | x² + Ex + 8 | 64 | x² + Fx + 8 | 68 |
| x² + 9x + A | 6A | x² + Ax + 9 | 7A | x² + Bx + C | 77 | x² + Cx + 8 | 73 | x² + Dx + 8 | 7D | x² + Ex + 8 | 66 | x² + Fx + 8 | 6C |
| x² + 9x + A | 8A | x² + Ax + 9 | 9B | x² + Bx + C | A9 | x² + Cx + 8 | D4 | x² + Dx + 8 | 89 | x² + Ex + 8 | CA | x² + Fx + 8 | B1 |
| x² + 9x + A | 8E | x² + Ax + 9 | 9E | x² + Bx + C | AB | x² + Cx + 8 | D7 | x² + Dx + 8 | 8B | x² + Ex + 8 | CE | x² + Fx + 8 | B2 |
| x² + 9x + A | AB | x² + Ax + 9 | B4 | x² + Bx + C | F8 | x² + Cx + 8 | E0 | x² + Dx + 8 | C8 | x² + Ex + 8 | FB | x² + Fx + 8 | E0 |
| x² + 9x + A | AE | x² + Ax + 9 | B6 | x² + Bx + C | FB | x² + Cx + 8 | E4 | x² + Dx + 8 | CB | x² + Ex + 8 | FE | x² + Fx + 8 | E5 |
| x² + 9x + B | 45 | x² + Ax + A | 50 | x² + Bx + D | 29 | x² + Cx + A | 43 | x² + Dx + 9 | 32 | x² + Ex + 9 | 58 | x² + Fx + B | 3D |
| x² + 9x + B | 47 | x² + Ax + A | 54 | x² + Bx + D | 2C | x² + Cx + A | 46 | x² + Dx + 9 | 36 | x² + Ex + 9 | 5B | x² + Fx + B | 3F |
| x² + 9x + B | 61 | x² + Ax + A | 74 | x² + Bx + D | 79 | x² + Cx + A | 78 | x² + Dx + 9 | 71 | x² + Ex + 9 | 69 | x² + Fx + B | 6B |
| x² + 9x + B | 62 | x² + Ax + A | 77 | x² + Bx + D | 7D | x² + Cx + A | 7A | x² + Dx + 9 | 74 | x² + Ex + 9 | 6B | x² + Fx + B | 6F |
| x² + 9x + B | 88 | x² + Ax + A | 9A | x² + Bx + D | AC | x² + Cx + A | D0 | x² + Dx + 9 | 80 | x² + Ex + 9 | C3 | x² + Fx + B | BD |
| x² + 9x + B | 8C | x² + Ax + A | 9F | x² + Bx + D | AE | x² + Cx + A | D3 | x² + Dx + 9 | 82 | x² + Ex + 9 | C7 | x² + Fx + B | BE |
| x² + 9x + B | A0 | x² + Ax + A | B1 | x² + Bx + D | F5 | x² + Cx + A | E1 | x² + Dx + 9 | CC | x² + Ex + 9 | F8 | x² + Fx + B | E2 |
| x² + 9x + B | A5 | x² + Ax + A | B3 | x² + Bx + D | F6 | x² + Cx + A | E5 | x² + Dx + 9 | CF | x² + Ex + 9 | FD | x² + Fx + B | E7 |
| x² + 9x + E | 4D | x² + Ax + C | 52 | x² + Bx + E | 23 | x² + Cx + C | 40 | x² + Dx + A | 3B | x² + Ex + C | 55 | x² + Fx + C | 38 |
| x² + 9x + E | 4F | x² + Ax + C | 56 | x² + Bx + E | 26 | x² + Cx + C | 45 | x² + Dx + A | 3F | x² + Ex + C | 56 | x² + Fx + C | 3A |
| x² + 9x + E | 6D | x² + Ax + C | 7C | x² + Bx + E | 71 | x² + Cx + C | 75 | x² + Dx + A | 72 | x² + Ex + C | 6C | x² + Fx + C | 61 |
| x² + 9x + E | 6E | x² + Ax + C | 7F | x² + Bx + E | 75 | x² + Cx + C | 77 | x² + Dx + A | 77 | x² + Ex + C | 6E | x² + Fx + C | 65 |
| x² + 9x + E | 8B | x² + Ax + C | 91 | x² + Bx + E | A8 | x² + Cx + C | D1 | x² + Dx + A | 8D | x² + Ex + C | C9 | x² + Fx + C | B0 |
| x² + 9x + E | 8F | x² + Ax + C | 94 | x² + Bx + E | AA | x² + Cx + C | D2 | x² + Dx + A | 8F | x² + Ex + C | CD | x² + Fx + C | B3 |
| x² + 9x + E | A2 | x² + Ax + C | B0 | x² + Bx + E | F0 | x² + Cx + C | E8 | x² + Dx + A | CD | x² + Ex + C | F9 | x² + Fx + C | E3 |
| x² + 9x + E | A7 | x² + Ax + C | B2 | x² + Bx + E | F3 | x² + Cx + C | EC | x² + Dx + A | CE | x² + Ex + C | FC | x² + Fx + C | E6 |
| x² + 9x + F | 4C | x² + Ax + F | 58 | x² + Bx + F | 22 | x² + Cx + E | 49 | x² + Dx + B | 3A | x² + Ex + D | 54 | x² + Fx + F | 30 |
| x² + 9x + F | 4E | x² + Ax + F | 5C | x² + Bx + F | 27 | x² + Cx + E | 4C | x² + Dx + B | 3E | x² + Ex + D | 57 | x² + Fx + F | 32 |
| x² + 9x + F | 65 | x² + Ax + F | 71 | x² + Bx + F | 7B | x² + Cx + E | 7C | x² + Dx + B | 7B | x² + Ex + D | 61 | x² + Fx + F | 62 |
| x² + 9x + F | 66 | x² + Ax + F | 72 | x² + Bx + F | 7F | x² + Cx + E | 7E | x² + Dx + B | 7E | x² + Ex + D | 63 | x² + Fx + F | 66 |
| x² + 9x + F | 89 | x² + Ax + F | 90 | x² + Bx + F | AD | x² + Cx + E | D5 | x² + Dx + B | 84 | x² + Ex + D | C0 | x² + Fx + F | BC |
| x² + 9x + F | 8D | x² + Ax + F | 95 | x² + Bx + F | AF | x² + Cx + E | D6 | x² + Dx + B | 86 | x² + Ex + D | C4 | x² + Fx + F | BF |
| x² + 9x + F | A9 | x² + Ax + F | B5 | x² + Bx + F | FD | x² + Cx + E | E9 | x² + Dx + B | C9 | x² + Ex + D | FA | x² + Fx + F | E1 |
| x² + 9x + F | AC | x² + Ax + F | B7 | x² + Bx + F | FE | x² + Cx + E | ED | x² + Dx + B | CA | x² + Ex + D | FF | x² + Fx + F | E4 |

Ground-Field Poly x⁴ + x³ + 1

| C-F poly | Basis | C-F poly | Basis | C-F poly | Basis | C-F poly | Basis | C-F poly | Basis | C-F poly | Basis | C-F poly | Basis | C-F poly | Basis |
|---|---|---|---|---|---|---|---|---|---|---|---|---|---|---|---|
| x² + 1x + 2 | 62 | x² + 2x + 8 | 32 | x² + 3x + 1 | 23 | x² + 4x + 2 | 30 | x² + 5x + 1 | 45 | x² + 6x + 1 | 19 | x² + 7x + 1 | 12 | x² + 8x + 1 | 98 |
| x² + 1x + 2 | 64 | x² + 2x + 8 | 34 | x² + 3x + 1 | 25 | x² + 4x + 2 | 3C | x² + 5x + 1 | 48 | x² + 6x + 1 | 1F | x² + 7x + 1 | 15 | x² + 8x + 1 | 9F |
| x² + 1x + 2 | 72 | x² + 2x + 8 | 65 | x² + 3x + 1 | 47 | x² + 4x + 2 | 55 | x² + 5x + 1 | 61 | x² + 6x + 1 | 26 | x² + 7x + 1 | 75 | x² + 8x + 1 | A0 |
| x² + 1x + 2 | 75 | x² + 2x + 8 | 69 | x² + 3x + 1 | 4B | x² + 4x + 2 | 58 | x² + 5x + 1 | 66 | x² + 6x + 1 | 2A | x² + 7x + 1 | 79 | x² + 8x + 1 | A6 |
| x² + 1x + 2 | C5 | x² + 2x + 8 | A7 | x² + 3x + 1 | A0 | x² + 4x + 2 | B1 | x² + 5x + 1 | 9A | x² + 6x + 1 | 59 | x² + 7x + 1 | 97 | x² + 8x + 1 | D1 |
| x² + 1x + 2 | C9 | x² + 2x + 8 | AA | x² + 3x + 1 | A7 | x² + 4x + 2 | B6 | x² + 5x + 1 | 9C | x² + 6x + 1 | 5E | x² + 7x + 1 | 9A | x² + 8x + 1 | DD |
| x² + 1x + 2 | D7 | x² + 2x + 8 | F2 | x² + 3x + 1 | C1 | x² + 4x + 2 | DA | x² + 5x + 1 | B0 | x² + 6x + 1 | 62 | x² + 7x + 1 | F2 | x² + 8x + 1 | E6 |
| x² + 1x + 2 | DA | x² + 2x + 8 | F5 | x² + 3x + 1 | CC | x² + 4x + 2 | DC | x² + 5x + 1 | BC | x² + 6x + 1 | 6F | x² + 7x + 1 | F4 | x² + 8x + 1 | EB |
| x² + 1x + 3 | 6A | x² + 2x + 9 | 38 | x² + 3x + 3 | 21 | x² + 4x + 3 | 32 | x² + 5x + 3 | 46 | x² + 6x + 3 | 12 | x² + 7x + 2 | 1B | x² + 8x + 3 | 90 |
| x² + 1x + 3 | 6C | x² + 2x + 9 | 3E | x² + 3x + 3 | 27 | x² + 4x + 3 | 3E | x² + 5x + 3 | 4B | x² + 6x + 3 | 14 | x² + 7x + 2 | 1C | x² + 8x + 3 | 97 |
| x² + 1x + 3 | 71 | x² + 2x + 9 | 64 | x² + 3x + 3 | 43 | x² + 4x + 3 | 53 | x² + 5x + 3 | 68 | x² + 6x + 3 | 25 | x² + 7x + 2 | 74 | x² + 8x + 3 | A3 |
| x² + 1x + 3 | 76 | x² + 2x + 9 | 68 | x² + 3x + 3 | 4F | x² + 4x + 3 | 5B | x² + 5x + 3 | 6F | x² + 6x + 3 | 29 | x² + 7x + 2 | 78 | x² + 8x + 3 | A5 |
| x² + 1x + 3 | C0 | x² + 2x + 9 | A4 | x² + 3x + 3 | AA | x² + 4x + 3 | B3 | x² + 5x + 3 | 90 | x² + 6x + 3 | 52 | x² + 7x + 2 | 94 | x² + 8x + 3 | D7 |
| x² + 1x + 3 | CC | x² + 2x + 9 | A9 | x² + 3x + 3 | AD | x² + 4x + 3 | B4 | x² + 5x + 3 | 96 | x² + 6x + 3 | 55 | x² + 7x + 2 | 99 | x² + 8x + 3 | DB |
| x² + 1x + 3 | D5 | x² + 2x + 9 | FB | x² + 3x + 3 | C0 | x² + 4x + 3 | DB | x² + 5x + 3 | B1 | x² + 6x + 3 | 67 | x² + 7x + 2 | F8 | x² + 8x + 3 | E1 |
| x² + 1x + 3 | D8 | x² + 2x + 9 | FC | x² + 3x + 3 | CD | x² + 4x + 3 | DD | x² + 5x + 3 | BD | x² + 6x + 3 | 6A | x² + 7x + 2 | FE | x² + 8x + 3 | EC |
| x² + 1x + 4 | 68 | x² + 2x + A | 3B | x² + 3x + 4 | 2B | x² + 4x + 6 | 31 | x² + 5x + 5 | 41 | x² + 6x + 4 | 13 | x² + 7x + 4 | 1A | x² + 8x + 5 | 9A |
| x² + 1x + 4 | 6E | x² + 2x + A | 3D | x² + 3x + 4 | 2D | x² + 4x + 6 | 3D | x² + 5x + 5 | 4C | x² + 6x + 4 | 15 | x² + 7x + 4 | 1D | x² + 8x + 5 | 9D |
| x² + 1x + 4 | 7B | x² + 2x + A | 62 | x² + 3x + 4 | 42 | x² + 4x + 6 | 56 | x² + 5x + 5 | 60 | x² + 6x + 4 | 27 | x² + 7x + 4 | 73 | x² + 8x + 5 | A1 |
| x² + 1x + 4 | 7C | x² + 2x + A | 6E | x² + 3x + 4 | 4E | x² + 4x + 6 | 5B | x² + 5x + 5 | 67 | x² + 6x + 4 | 2B | x² + 7x + 4 | 7F | x² + 8x + 5 | A7 |
| x² + 1x + 4 | C4 | x² + 2x + A | A3 | x² + 3x + 4 | A3 | x² + 4x + 6 | B8 | x² + 5x + 5 | 93 | x² + 6x + 4 | 50 | x² + 7x + 4 | 90 | x² + 8x + 5 | D3 |
| x² + 1x + 4 | C8 | x² + 2x + A | AE | x² + 3x + 4 | A4 | x² + 4x + 6 | BF | x² + 5x + 5 | 95 | x² + 6x + 4 | 57 | x² + 7x + 4 | 9D | x² + 8x + 5 | DF |
| x² + 1x + 4 | D4 | x² + 2x + A | F3 | x² + 3x + 4 | C3 | x² + 4x + 6 | D0 | x² + 5x + 5 | B7 | x² + 6x + 4 | 61 | x² + 7x + 4 | F1 | x² + 8x + 5 | E0 |
| x² + 1x + 4 | D9 | x² + 2x + A | F4 | x² + 3x + 4 | CE | x² + 4x + 6 | D6 | x² + 5x + 5 | BB | x² + 6x + 4 | 6C | x² + 7x + 4 | F7 | x² + 8x + 5 | ED |
| x² + 1x + 5 | 60 | x² + 2x + B | 31 | x² + 3x + 6 | 29 | x² + 4x + 7 | 33 | x² + 5x + 7 | 42 | x² + 6x + 6 | 18 | x² + 7x + 7 | 13 | x² + 8x + 7 | 92 |
| x² + 1x + 5 | 66 | x² + 2x + B | 37 | x² + 3x + 6 | 2F | x² + 4x + 7 | 3F | x² + 5x + 7 | 4F | x² + 6x + 6 | 1E | x² + 7x + 7 | 14 | x² + 8x + 7 | 95 |
| x² + 1x + 5 | 78 | x² + 2x + B | 63 | x² + 3x + 6 | 46 | x² + 4x + 7 | 50 | x² + 5x + 7 | 69 | x² + 6x + 6 | 24 | x² + 7x + 7 | 72 | x² + 8x + 7 | A2 |
| x² + 1x + 5 | 7F | x² + 2x + B | 6F | x² + 3x + 6 | 4A | x² + 4x + 7 | 5D | x² + 5x + 7 | 6E | x² + 6x + 6 | 28 | x² + 7x + 7 | 7E | x² + 8x + 7 | A4 |
| x² + 1x + 5 | C1 | x² + 2x + B | A0 | x² + 3x + 6 | A9 | x² + 4x + 7 | BA | x² + 5x + 7 | 99 | x² + 6x + 6 | 5B | x² + 7x + 7 | 93 | x² + 8x + 7 | D5 |
| x² + 1x + 5 | CD | x² + 2x + B | AD | x² + 3x + 6 | AE | x² + 4x + 7 | BD | x² + 5x + 7 | 9F | x² + 6x + 6 | 5C | x² + 7x + 7 | 9E | x² + 8x + 7 | D9 |
| x² + 1x + 5 | D6 | x² + 2x + B | FA | x² + 3x + 6 | C2 | x² + 4x + 7 | D1 | x² + 5x + 7 | B6 | x² + 6x + 6 | 64 | x² + 7x + 7 | FB | x² + 8x + 7 | E7 |
| x² + 1x + 5 | DB | x² + 2x + B | FD | x² + 3x + 6 | CF | x² + 4x + 7 | D7 | x² + 5x + 7 | 8A | x² + 6x + 6 | 69 | x² + 7x + 7 | FD | x² + 8x + 7 | EA |
| x² + 1x + 8 | 61 | x² + 2x + C | 3A | x² + 3x + 8 | 20 | x² + 4x + A | 37 | x² + 5x + 9 | 47 | x² + 6x + 9 | 1B | x² + 7x + 8 | 19 | x² + 8x + 8 | 91 |
| x² + 1x + 8 | 67 | x² + 2x + C | 3C | x² + 3x + 8 | 26 | x² + 4x + A | 3B | x² + 5x + 9 | 4A | x² + 6x + 9 | 1D | x² + 7x + 8 | 1E | x² + 8x + 8 | 96 |
| x² + 1x + 8 | 7A | x² + 2x + C | 60 | x² + 3x + 8 | 41 | x² + 4x + A | 51 | x² + 5x + 9 | 62 | x² + 6x + 9 | 22 | x² + 7x + 8 | 76 | x² + 8x + 8 | AA |
| x² + 1x + 8 | 7D | x² + 2x + C | 6C | x² + 3x + 8 | 4D | x² + 4x + A | 5C | x² + 5x + 9 | 65 | x² + 6x + 9 | 2E | x² + 7x + 8 | 7A | x² + 8x + 8 | AC |
| x² + 1x + 8 | C3 | x² + 2x + C | A5 | x² + 3x + 8 | A8 | x² + 4x + A | B0 | x² + 5x + 9 | 92 | x² + 6x + 9 | 53 | x² + 7x + 8 | 92 | x² + 8x + 8 | D0 |
| x² + 1x + 8 | CF | x² + 2x + C | A8 | x² + 3x + 8 | AF | x² + 4x + A | B7 | x² + 5x + 9 | 94 | x² + 6x + 9 | 54 | x² + 7x + 8 | 9F | x² + 8x + 8 | DC |
| x² + 1x + 8 | D0 | x² + 2x + C | F1 | x² + 3x + 8 | C6 | x² + 4x + A | D3 | x² + 5x + 9 | B5 | x² + 6x + 9 | 63 | x² + 7x + 8 | F9 | x² + 8x + 8 | E5 |
| x² + 1x + 8 | DD | x² + 2x + C | F6 | x² + 3x + 8 | CB | x² + 4x + A | D5 | x² + 5x + 9 | B9 | x² + 6x + 9 | 6E | x² + 7x + 8 | FF | x² + 8x + 8 | E8 |
| x² + 1x + 9 | 69 | x² + 2x + D | 30 | x² + 3x + A | 22 | x² + 4x + B | 35 | x² + 5x + B | 44 | x² + 6x + B | 10 | x² + 7x + B | 10 | x² + 8x + A | 99 |
| x² + 1x + 9 | 6F | x² + 2x + D | 36 | x² + 3x + A | 24 | x² + 4x + B | 39 | x² + 5x + B | 49 | x² + 6x + B | 16 | x² + 7x + B | 17 | x² + 8x + A | 9E |
| x² + 1x + 9 | 79 | x² + 2x + D | 61 | x² + 3x + A | 45 | x² + 4x + B | 57 | x² + 5x + B | 6B | x² + 6x + B | 21 | x² + 7x + B | 77 | x² + 8x + A | A9 |
| x² + 1x + 9 | 7E | x² + 2x + D | 6D | x² + 3x + A | 49 | x² + 4x + B | 5A | x² + 5x + B | 6C | x² + 6x + B | 2D | x² + 7x + B | 7B | x² + 8x + A | AF |
| x² + 1x + 9 | C6 | x² + 2x + D | A6 | x² + 3x + A | A2 | x² + 4x + B | B2 | x² + 5x + B | 98 | x² + 6x + B | 58 | x² + 7x + B | 91 | x² + 8x + A | D6 |
| x² + 1x + 9 | CA | x² + 2x + D | AB | x² + 3x + A | A5 | x² + 4x + B | B5 | x² + 5x + B | 9E | x² + 6x + B | 5F | x² + 7x + B | 9C | x² + 8x + A | DA |
| x² + 1x + 9 | D2 | x² + 2x + D | F8 | x² + 3x + A | C7 | x² + 4x + B | D2 | x² + 5x + B | B4 | x² + 6x + B | 66 | x² + 7x + B | F3 | x² + 8x + A | E2 |
| x² + 1x + 9 | DF | x² + 2x + D | FF | x² + 3x + A | CA | x² + 4x + B | D4 | x² + 5x + B | B8 | x² + 6x + B | 6B | x² + 7x + B | F5 | x² + 8x + A | EF |
| x² + 1x + E | 6B | x² + 2x + E | 33 | x² + 3x + D | 28 | x² + 4x + E | 36 | x² + 5x + D | 43 | x² + 6x + C | 11 | x² + 7x + D | 11 | x² + 8x + C | 93 |
| x² + 1x + E | 6D | x² + 2x + E | 35 | x² + 3x + D | 2E | x² + 4x + E | 3A | x² + 5x + D | 4E | x² + 6x + C | 17 | x² + 7x + D | 16 | x² + 8x + C | 94 |
| x² + 1x + E | 73 | x² + 2x + E | 67 | x² + 3x + D | 44 | x² + 4x + E | 52 | x² + 5x + D | 63 | x² + 6x + C | 23 | x² + 7x + D | 70 | x² + 8x + C | AB |
| x² + 1x + E | 74 | x² + 2x + E | 6B | x² + 3x + D | 48 | x² + 4x + E | 5F | x² + 5x + D | 64 | x² + 6x + C | 2F | x² + 7x + D | 7C | x² + 8x + C | AD |
| x² + 1x + E | C2 | x² + 2x + E | A1 | x² + 3x + D | AB | x² + 4x + E | B9 | x² + 5x + D | 9B | x² + 6x + C | 5A | x² + 7x + D | 95 | x² + 8x + C | D2 |
| x² + 1x + E | CE | x² + 2x + E | AC | x² + 3x + D | AC | x² + 4x + E | BE | x² + 5x + D | 9D | x² + 6x + C | 5D | x² + 7x + D | 98 | x² + 8x + C | DE |
| x² + 1x + E | D3 | x² + 2x + E | F0 | x² + 3x + D | C4 | x² + 4x + E | D9 | x² + 5x + D | B2 | x² + 6x + C | 60 | x² + 7x + D | FA | x² + 8x + C | E3 |
| x² + 1x + E | DE | x² + 2x + E | F7 | x² + 3x + D | C9 | x² + 4x + E | DF | x² + 5x + D | BE | x² + 6x + C | 6D | x² + 7x + D | FC | x² + 8x + C | EE |
| x² + 1x + F | 63 | x² + 2x + F | 39 | x² + 3x + F | 2A | x² + 4x + F | 34 | x² + 5x + F | 40 | x² + 6x + E | 1A | x² + 7x + E | 18 | x² + 8x + E | 9B |
| x² + 1x + F | 65 | x² + 2x + F | 3F | x² + 3x + F | 2C | x² + 4x + F | 38 | x² + 5x + F | 4D | x² + 6x + E | 1C | x² + 7x + E | 1F | x² + 8x + E | 9C |
| x² + 1x + F | 70 | x² + 2x + F | 66 | x² + 3x + F | 40 | x² + 4x + F | 54 | x² + 5x + F | 6A | x² + 6x + E | 20 | x² + 7x + E | 71 | x² + 8x + E | A8 |
| x² + 1x + F | 77 | x² + 2x + F | 6A | x² + 3x + F | 4C | x² + 4x + F | 59 | x² + 5x + F | 6D | x² + 6x + E | 2C | x² + 7x + E | 7D | x² + 8x + E | AE |
| x² + 1x + F | C7 | x² + 2x + F | A2 | x² + 3x + F | A1 | x² + 4x + F | BB | x² + 5x + F | 91 | x² + 6x + E | 51 | x² + 7x + E | 96 | x² + 8x + E | D4 |
| x² + 1x + F | CB | x² + 2x + F | AF | x² + 3x + F | A6 | x² + 4x + F | BC | x² + 5x + F | 97 | x² + 6x + E | 56 | x² + 7x + E | 9B | x² + 8x + E | D8 |
| x² + 1x + F | D1 | x² + 2x + F | F9 | x² + 3x + F | C5 | x² + 4x + F | D8 | x² + 5x + F | B3 | x² + 6x + E | 65 | x² + 7x + E | F0 | x² + 8x + E | E4 |
| x² + 1x + F | DC | x² + 2x + F | FE | x² + 3x + F | C8 | x² + 4x + F | DE | x² + 5x + F | BF | x² + 6x + E | 68 | x² + 7x + E | F6 | x² + 8x + E | E9 |

Ground-Field Poly x⁴ + x³ + 1

| C-F poly | Basis | C-F poly | Basis | C-F poly | Basis | C-F poly | Basis | C-F poly | Basis | C-F poly | Basis | C-F poly | Basis |
|---|---|---|---|---|---|---|---|---|---|---|---|---|---|
| x² + 9x + 2 | 5B | x² + Ax + 4 | 25 | x² + Bx + 2 | 40 | x² + Cx + 1 | 14 | x² + Dx + 1 | 13 | x² + Ex + 4 | 87 | x² + Fx + 1 | 2A |
| x² + 9x + 2 | 5D | x² + Ax + 4 | 28 | x² + Bx + 2 | 47 | x² + Cx + 1 | 18 | x² + Dx + 1 | 1E | x² + Ex + 4 | 8A | x² + Fx + 1 | 2D |
| x² + 9x + 2 | 73 | x² + Ax + 4 | 31 | x² + Bx + 2 | 57 | x² + Cx + 1 | 34 | x² + Dx + 1 | 4B | x² + Ex + 4 | B2 | x² + Fx + 1 | 71 |
| x² + 9x + 2 | 7E | x² + Ax + 4 | 36 | x² + Bx + 2 | 5B | x² + Cx + 1 | 39 | x² + Dx + 1 | 4D | x² + Ex + 4 | B4 | x² + Fx + 1 | 77 |
| x² + 9x + 2 | 83 | x² + Ax + 4 | 8A | x² + Bx + 2 | E3 | x² + Cx + 1 | C8 | x² + Dx + 1 | 82 | x² + Ex + 4 | C2 | x² + Fx + 1 | B0 |
| x² + 9x + 2 | 84 | x² + Ax + 4 | 8C | x² + Bx + 2 | E5 | x² + Cx + 1 | CE | x² + Dx + 1 | 8E | x² + Ex + 4 | C5 | x² + Fx + 1 | BD |
| x² + 9x + 2 | A2 | x² + Ax + 4 | 90 | x² + Bx + 2 | F1 | x² + Cx + 1 | EB | x² + Dx + 1 | D3 | x² + Ex + 4 | F5 | x² + Fx + 1 | E3 |
| x² + 9x + 2 | AE | x² + Ax + 4 | 9C | x² + Bx + 2 | FC | x² + Cx + 1 | EC | x² + Dx + 1 | D4 | x² + Ex + 4 | F9 | x² + Fx + 1 | EF |
| x² + 9x + 3 | 59 | x² + Ax + 5 | 22 | x² + Bx + 3 | 4B | x² + Cx + 2 | 13 | x² + Dx + 2 | 16 | x² + Ex + 5 | 83 | x² + Fx + 2 | 29 |
| x² + 9x + 3 | 5F | x² + Ax + 5 | 2F | x² + Bx + 3 | 4C | x² + Cx + 2 | 1F | x² + Dx + 2 | 1B | x² + Ex + 5 | 8E | x² + Fx + 2 | 2E |
| x² + 9x + 3 | 72 | x² + Ax + 5 | 39 | x² + Bx + 3 | 54 | x² + Cx + 2 | 30 | x² + Dx + 2 | 40 | x² + Ex + 5 | BB | x² + Fx + 2 | 79 |
| x² + 9x + 3 | 7F | x² + Ax + 5 | 3E | x² + Bx + 3 | 58 | x² + Cx + 2 | 3D | x² + Dx + 2 | 46 | x² + Ex + 5 | BD | x² + Fx + 2 | 7F |
| x² + 9x + 3 | 89 | x² + Ax + 5 | 89 | x² + Bx + 3 | E8 | x² + Cx + 2 | C1 | x² + Dx + 2 | 81 | x² + Ex + 5 | C3 | x² + Fx + 2 | B2 |
| x² + 9x + 3 | 8E | x² + Ax + 5 | 8F | x² + Bx + 3 | EE | x² + Cx + 2 | C7 | x² + Dx + 2 | 8D | x² + Ex + 5 | C4 | x² + Fx + 2 | BF |
| x² + 9x + 3 | A6 | x² + Ax + 5 | 96 | x² + Bx + 3 | F4 | x² + Cx + 2 | EA | x² + Dx + 2 | D8 | x² + Ex + 5 | F2 | x² + Fx + 2 | E6 |
| x² + 9x + 3 | AA | x² + Ax + 5 | 9A | x² + Bx + 3 | F9 | x² + Cx + 2 | ED | x² + Dx + 2 | DF | x² + Ex + 5 | FE | x² + Fx + 2 | EA |
| x² + 9x + 4 | 50 | x² + Ax + 6 | 23 | x² + Bx + 6 | 4A | x² + Cx + 4 | 16 | x² + Dx + 5 | 14 | x² + Ex + 6 | 85 | x² + Fx + 5 | 21 |
| x² + 9x + 4 | 56 | x² + Ax + 6 | 2E | x² + Bx + 6 | 4D | x² + Cx + 4 | 1A | x² + Dx + 5 | 19 | x² + Ex + 6 | 88 | x² + Fx + 5 | 26 |
| x² + 9x + 4 | 76 | x² + Ax + 6 | 33 | x² + Bx + 6 | 53 | x² + Cx + 4 | 32 | x² + Dx + 5 | 48 | x² + Ex + 6 | BA | x² + Fx + 5 | 7A |
| x² + 9x + 4 | 7B | x² + Ax + 6 | 34 | x² + Bx + 6 | 5F | x² + Cx + 4 | 3F | x² + Dx + 5 | 4E | x² + Ex + 6 | BC | x² + Fx + 5 | 7C |
| x² + 9x + 4 | 88 | x² + Ax + 6 | 8B | x² + Bx + 6 | E1 | x² + Cx + 4 | C9 | x² + Dx + 5 | 84 | x² + Ex + 6 | C1 | x² + Fx + 5 | B5 |
| x² + 9x + 4 | 8F | x² + Ax + 6 | 8D | x² + Bx + 6 | E7 | x² + Cx + 4 | CF | x² + Dx + 5 | 88 | x² + Ex + 6 | C6 | x² + Fx + 5 | B8 |
| x² + 9x + 4 | A1 | x² + Ax + 6 | 92 | x² + Bx + 6 | F0 | x² + Cx + 4 | E9 | x² + Dx + 5 | DB | x² + Ex + 6 | F0 | x² + Fx + 5 | E0 |
| x² + 9x + 4 | AD | x² + Ax + 6 | 9E | x² + Bx + 6 | FD | x² + Cx + 4 | EE | x² + Dx + 5 | DC | x² + Ex + 6 | FC | x² + Fx + 5 | EC |
| x² + 9x + 5 | 52 | x² + Ax + 7 | 24 | x² + Bx + 7 | 41 | x² + Cx + 7 | 11 | x² + Dx + 6 | 11 | x² + Ex + 7 | 81 | x² + Fx + 6 | 22 |
| x² + 9x + 5 | 54 | x² + Ax + 7 | 29 | x² + Bx + 7 | 46 | x² + Cx + 7 | 1D | x² + Dx + 6 | 1C | x² + Ex + 7 | 8C | x² + Fx + 6 | 25 |
| x² + 9x + 5 | 77 | x² + Ax + 7 | 3B | x² + Bx + 7 | 50 | x² + Cx + 7 | 36 | x² + Dx + 6 | 43 | x² + Ex + 7 | B3 | x² + Fx + 6 | 72 |
| x² + 9x + 5 | 7A | x² + Ax + 7 | 3C | x² + Bx + 7 | 5C | x² + Cx + 7 | 3B | x² + Dx + 6 | 45 | x² + Ex + 7 | B5 | x² + Fx + 6 | 74 |
| x² + 9x + 5 | 82 | x² + Ax + 7 | 88 | x² + Bx + 7 | EA | x² + Cx + 7 | C0 | x² + Dx + 6 | 87 | x² + Ex + 7 | C0 | x² + Fx + 6 | B7 |
| x² + 9x + 5 | 85 | x² + Ax + 7 | 8E | x² + Bx + 7 | EC | x² + Cx + 7 | C6 | x² + Dx + 6 | 8B | x² + Ex + 7 | C7 | x² + Fx + 6 | BA |
| x² + 9x + 5 | A5 | x² + Ax + 7 | 94 | x² + Bx + 7 | F5 | x² + Cx + 7 | E8 | x² + Dx + 6 | D0 | x² + Ex + 7 | F7 | x² + Fx + 6 | E5 |
| x² + 9x + 5 | A9 | x² + Ax + 7 | 98 | x² + Bx + 7 | F8 | x² + Cx + 7 | EF | x² + Dx + 6 | D7 | x² + Ex + 7 | FB | x² + Fx + 6 | E9 |
| x² + 9x + A | 58 | x² + Ax + C | 26 | x² + Bx + 8 | 43 | x² + Cx + 9 | 17 | x² + Dx + 9 | 15 | x² + Ex + 8 | 84 | x² + Fx + 8 | 20 |
| x² + 9x + A | 5E | x² + Ax + C | 2B | x² + Bx + 8 | 44 | x² + Cx + 9 | 1B | x² + Dx + 9 | 18 | x² + Ex + 8 | 89 | x² + Fx + 8 | 27 |
| x² + 9x + A | 74 | x² + Ax + C | 38 | x² + Bx + 8 | 52 | x² + Cx + 9 | 31 | x² + Dx + 9 | 4A | x² + Ex + 8 | B8 | x² + Fx + 8 | 73 |
| x² + 9x + A | 79 | x² + Ax + C | 3F | x² + Bx + 8 | 5E | x² + Cx + 9 | 3C | x² + Dx + 9 | 4C | x² + Ex + 8 | BE | x² + Fx + 8 | 75 |
| x² + 9x + A | 8B | x² + Ax + C | 80 | x² + Bx + 8 | EB | x² + Cx + 9 | C3 | x² + Dx + 9 | 80 | x² + Ex + 8 | CB | x² + Fx + 8 | B1 |
| x² + 9x + A | 8C | x² + Ax + C | 86 | x² + Bx + 8 | ED | x² + Cx + 9 | C5 | x² + Dx + 9 | 8C | x² + Ex + 8 | CC | x² + Fx + 8 | BC |
| x² + 9x + A | A4 | x² + Ax + C | 91 | x² + Bx + 8 | F3 | x² + Cx + 9 | E0 | x² + Dx + 9 | D1 | x² + Ex + 8 | F4 | x² + Fx + 8 | E7 |
| x² + 9x + A | A8 | x² + Ax + C | 9D | x² + Bx + 8 | FE | x² + Cx + 9 | E7 | x² + Dx + 9 | D6 | x² + Ex + 8 | F8 | x² + Fx + 8 | EB |
| x² + 9x + B | 5A | x² + Ax + D | 21 | x² + Bx + 9 | 48 | x² + Cx + A | 10 | x² + Dx + A | 10 | x² + Ex + 9 | 80 | x² + Fx + B | 23 |
| x² + 9x + B | 5C | x² + Ax + D | 2C | x² + Bx + 9 | 4F | x² + Cx + A | 1C | x² + Dx + A | 1D | x² + Ex + 9 | 8D | x² + Fx + B | 24 |
| x² + 9x + B | 75 | x² + Ax + D | 30 | x² + Bx + 9 | 51 | x² + Cx + A | 35 | x² + Dx + A | 41 | x² + Ex + 9 | B1 | x² + Fx + B | 7B |
| x² + 9x + B | 78 | x² + Ax + D | 37 | x² + Bx + 9 | 5D | x² + Cx + A | 38 | x² + Dx + A | 47 | x² + Ex + 9 | B7 | x² + Fx + B | 7D |
| x² + 9x + B | 81 | x² + Ax + D | 83 | x² + Bx + 9 | E0 | x² + Cx + A | CA | x² + Dx + A | 83 | x² + Ex + 9 | CA | x² + Fx + B | B3 |
| x² + 9x + B | 86 | x² + Ax + D | 85 | x² + Bx + 9 | E6 | x² + Cx + A | CC | x² + Dx + A | 8F | x² + Ex + 9 | CD | x² + Fx + B | BE |
| x² + 9x + B | A0 | x² + Ax + D | 97 | x² + Bx + 9 | F6 | x² + Cx + A | E1 | x² + Dx + A | DA | x² + Ex + 9 | F3 | x² + Fx + B | E2 |
| x² + 9x + B | AC | x² + Ax + D | 9B | x² + Bx + 9 | FB | x² + Cx + A | E6 | x² + Dx + A | DD | x² + Ex + 9 | FF | x² + Fx + B | EE |
| x² + 9x + C | 53 | x² + Ax + E | 20 | x² + Bx + C | 49 | x² + Cx + C | 15 | x² + Dx + D | 12 | x² + Ex + A | 86 | x² + Fx + C | 2B |
| x² + 9x + C | 55 | x² + Ax + E | 2D | x² + Bx + C | 4E | x² + Cx + C | 19 | x² + Dx + D | 1F | x² + Ex + A | 8B | x² + Fx + C | 2C |
| x² + 9x + C | 71 | x² + Ax + E | 3A | x² + Bx + C | 56 | x² + Cx + C | 37 | x² + Dx + D | 49 | x² + Ex + A | B0 | x² + Fx + C | 78 |
| x² + 9x + C | 7C | x² + Ax + E | 3D | x² + Bx + C | 5A | x² + Cx + C | 3A | x² + Dx + D | 4F | x² + Ex + A | B6 | x² + Fx + C | 7E |
| x² + 9x + C | 80 | x² + Ax + E | 81 | x² + Bx + C | E9 | x² + Cx + C | C2 | x² + Dx + D | 86 | x² + Ex + A | C8 | x² + Fx + C | B4 |
| x² + 9x + C | 87 | x² + Ax + E | 87 | x² + Bx + C | EF | x² + Cx + C | C4 | x² + Dx + D | 8A | x² + Ex + A | CF | x² + Fx + C | B9 |
| x² + 9x + C | A7 | x² + Ax + E | 93 | x² + Bx + C | F2 | x² + Cx + C | E2 | x² + Dx + D | D9 | x² + Ex + A | F1 | x² + Fx + C | E4 |
| x² + 9x + C | AB | x² + Ax + E | 9F | x² + Bx + C | FF | x² + Cx + C | E5 | x² + Dx + D | DE | x² + Ex + A | FD | x² + Fx + C | E8 |
| x² + 9x + D | 51 | x² + Ax + F | 27 | x² + Bx + D | 42 | x² + Cx + F | 12 | x² + Dx + E | 17 | x² + Ex + B | 82 | x² + Fx + F | 28 |
| x² + 9x + D | 57 | x² + Ax + F | 2A | x² + Bx + D | 45 | x² + Cx + F | 1E | x² + Dx + E | 1A | x² + Ex + B | 8F | x² + Fx + F | 2F |
| x² + 9x + D | 70 | x² + Ax + F | 32 | x² + Bx + D | 55 | x² + Cx + F | 33 | x² + Dx + E | 42 | x² + Ex + B | B9 | x² + Fx + F | 70 |
| x² + 9x + D | 7D | x² + Ax + F | 35 | x² + Bx + D | 59 | x² + Cx + F | 3E | x² + Dx + E | 44 | x² + Ex + B | BF | x² + Fx + F | 76 |
| x² + 9x + D | 8A | x² + Ax + F | 82 | x² + Bx + D | E2 | x² + Cx + F | CB | x² + Dx + E | 85 | x² + Ex + B | C9 | x² + Fx + F | B6 |
| x² + 9x + D | 8D | x² + Ax + F | 84 | x² + Bx + D | E4 | x² + Cx + F | CD | x² + Dx + E | 89 | x² + Ex + B | CE | x² + Fx + F | BB |
| x² + 9x + D | A3 | x² + Ax + F | 95 | x² + Bx + D | F7 | x² + Cx + F | E3 | x² + Dx + E | D2 | x² + Ex + B | F6 | x² + Fx + F | E1 |
| x² + 9x + D | AF | x² + Ax + F | 99 | x² + Bx + D | FA | x² + Cx + F | E4 | x² + Dx + E | D5 | x² + Ex + B | FA | x² + Fx + F | ED |

Ground-Field Poly = x⁴ + x³ + x² + x + 1

| C-F poly | Basis | C-F poly | Basis | C-F poly | Basis | C-F poly | Basis | C-F poly | Basis | C-F poly | Basis | C-F poly | Basis | C-F poly | Basis |
|---|---|---|---|---|---|---|---|---|---|---|---|---|---|---|---|
| x² + 1x + 2 | 6A | x² + 2x + 1 | 32 | x² + 3x + 8 | 28 | x² + 4x + 1 | 54 | x² + 5x + 2 | 23 | x² + 6x + 1 | 18 | x² + 7x + 1 | 13 | x² + 8x + 1 | 3B |
| x² + 1x + 2 | 6C | x² + 2x + 1 | 34 | x² + 3x + 8 | 2E | x² + 4x + 1 | 5F | x² + 5x + 2 | 29 | x² + 6x + 1 | 1E | x² + 7x + 1 | 14 | x² + 8x + 1 | 3C |
| x² + 1x + 2 | 71 | x² + 2x + 1 | 57 | x² + 3x + 8 | 66 | x² + 4x + 1 | 61 | x² + 5x + 2 | 42 | x² + 6x + 1 | 36 | x² + 7x + 1 | 74 | x² + 8x + 1 | 71 |
| x² + 1x + 2 | 76 | x² + 2x + 1 | 5D | x² + 3x + 8 | 6C | x² + 4x + 1 | 66 | x² + 5x + 2 | 49 | x² + 6x + 1 | 3C | x² + 7x + 1 | 7E | x² + 8x + 1 | 77 |
| x² + 1x + 2 | A0 | x² + 2x + 1 | A1 | x² + 3x + 8 | 89 | x² + 4x + 1 | D0 | x² + 5x + 2 | BB | x² + 6x + 1 | 49 | x² + 7x + 1 | 83 | x² + 8x + 1 | 92 |
| x² + 1x + 2 | AA | x² + 2x + 1 | AA | x² + 3x + 8 | 8E | x² + 4x + 1 | DA | x² + 5x + 2 | BD | x² + 6x + 1 | 4E | x² + 7x + 1 | 85 | x² + 8x + 1 | 98 |
| x² + 1x + 2 | B4 | x² + 2x + 1 | C0 | x² + 3x + 8 | C3 | x² + 4x + 1 | EA | x² + 5x + 2 | D2 | x² + 6x + 1 | 63 | x² + 7x + 1 | E7 | x² + 8x + 1 | D0 |
| x² + 1x + 2 | BF | x² + 2x + 1 | C7 | x² + 3x + 8 | C8 | x² + 4x + 1 | EC | x² + 5x + 2 | D5 | x² + 6x + 1 | 68 | x² + 7x + 1 | EC | x² + 8x + 1 | DB |
| x² + 1x + 3 | 63 | x² + 2x + 2 | 31 | x² + 3x + 9 | 22 | x² + 4x + 2 | 56 | x² + 5x + 3 | 20 | x² + 6x + 2 | 13 | x² + 7x + 3 | 1A | x² + 8x + 3 | 39 |
| x² + 1x + 3 | 65 | x² + 2x + 2 | 37 | x² + 3x + 9 | 24 | x² + 4x + 2 | 5D | x² + 5x + 3 | 2A | x² + 6x + 2 | 15 | x² + 7x + 3 | 1D | x² + 8x + 3 | 3E |
| x² + 1x + 3 | 73 | x² + 2x + 2 | 52 | x² + 3x + 9 | 67 | x² + 4x + 2 | 68 | x² + 5x + 3 | 44 | x² + 6x + 2 | 34 | x² + 7x + 3 | 75 | x² + 8x + 3 | 78 |
| x² + 1x + 3 | 74 | x² + 2x + 2 | 58 | x² + 3x + 9 | 6D | x² + 4x + 2 | 6F | x² + 5x + 3 | 4F | x² + 6x + 2 | 3E | x² + 7x + 3 | 7F | x² + 8x + 3 | 7E |
| x² + 1x + 3 | A4 | x² + 2x + 2 | A0 | x² + 3x + 9 | 80 | x² + 4x + 2 | D1 | x² + 5x + 3 | BA | x² + 6x + 2 | 43 | x² + 7x + 3 | 89 | x² + 8x + 3 | 96 |
| x² + 1x + 3 | AE | x² + 2x + 2 | AB | x² + 3x + 9 | 87 | x² + 4x + 2 | DB | x² + 5x + 3 | BC | x² + 6x + 2 | 44 | x² + 7x + 3 | 8F | x² + 8x + 3 | 9C |
| x² + 1x + 3 | B7 | x² + 2x + 2 | CB | x² + 3x + 9 | C1 | x² + 4x + 2 | E0 | x² + 5x + 3 | D1 | x² + 6x + 2 | 67 | x² + 7x + 3 | E5 | x² + 8x + 3 | D3 |
| x² + 1x + 3 | BC | x² + 2x + 2 | CC | x² + 3x + 9 | CA | x² + 4x + 2 | E6 | x² + 5x + 3 | D6 | x² + 6x + 2 | 6C | x² + 7x + 3 | EE | x² + 8x + 3 | D8 |
| x² + 1x + 4 | 60 | x² + 2x + 5 | 3B | x² + 3x + A | 2A | x² + 4x + 4 | 51 | x² + 5x + 6 | 21 | x² + 6x + 5 | 12 | x² + 7x + 5 | 1B | x² + 8x + 4 | 31 |
| x² + 1x + 4 | 66 | x² + 2x + 5 | 3D | x² + 3x + A | 2C | x² + 4x + 4 | 5A | x² + 5x + 6 | 2B | x² + 6x + 5 | 14 | x² + 7x + 5 | 1C | x² + 8x + 4 | 36 |
| x² + 1x + 4 | 78 | x² + 2x + 5 | 53 | x² + 3x + A | 60 | x² + 4x + 4 | 60 | x² + 5x + 6 | 46 | x² + 6x + 5 | 37 | x² + 7x + 5 | 72 | x² + 8x + 4 | 7A |
| x² + 1x + 4 | 7F | x² + 2x + 5 | 59 | x² + 3x + A | 6A | x² + 4x + 4 | 67 | x² + 5x + 6 | 4D | x² + 6x + 5 | 3D | x² + 7x + 5 | 78 | x² + 8x + 4 | 7C |
| x² + 1x + 4 | A1 | x² + 2x + 5 | A2 | x² + 3x + A | 81 | x² + 4x + 4 | D7 | x² + 5x + 6 | B0 | x² + 6x + 5 | 40 | x² + 7x + 5 | 81 | x² + 8x + 4 | 90 |
| x² + 1x + 4 | AB | x² + 2x + 5 | A9 | x² + 3x + A | 86 | x² + 4x + 4 | DD | x² + 5x + 6 | B6 | x² + 6x + 5 | 47 | x² + 7x + 5 | 87 | x² + 8x + 4 | 9A |
| x² + 1x + 4 | B6 | x² + 2x + 5 | C2 | x² + 3x + A | C4 | x² + 4x + 4 | E2 | x² + 5x + 6 | D8 | x² + 6x + 5 | 61 | x² + 7x + 5 | E0 | x² + 8x + 4 | D4 |
| x² + 1x + 4 | BD | x² + 2x + 5 | C5 | x² + 3x + A | CF | x² + 4x + 4 | E4 | x² + 5x + 6 | DF | x² + 6x + 5 | 6A | x² + 7x + 5 | EB | x² + 8x + 4 | DF |
| x² + 1x + 5 | 69 | x² + 2x + 6 | 38 | x² + 3x + B | 20 | x² + 4x + 7 | 53 | x² + 5x + 7 | 22 | x² + 6x + 6 | 19 | x² + 7x + 7 | 12 | x² + 8x + 6 | 33 |
| x² + 1x + 5 | 6F | x² + 2x + 6 | 3E | x² + 3x + B | 26 | x² + 4x + 7 | 58 | x² + 5x + 7 | 28 | x² + 6x + 6 | 1F | x² + 7x + 7 | 15 | x² + 8x + 6 | 34 |
| x² + 1x + 5 | 7A | x² + 2x + 6 | 56 | x² + 3x + B | 61 | x² + 4x + 7 | 69 | x² + 5x + 7 | 40 | x² + 6x + 6 | 35 | x² + 7x + 7 | 73 | x² + 8x + 6 | 73 |
| x² + 1x + 5 | 7D | x² + 2x + 6 | 5C | x² + 3x + B | 6B | x² + 4x + 7 | 68 | x² + 5x + 7 | 4B | x² + 6x + 6 | 8F | x² + 7x + 7 | 79 | x² + 8x + 6 | 75 |
| x² + 1x + 5 | A5 | x² + 2x + 6 | A3 | x² + 3x + B | 88 | x² + 4x + 7 | D6 | x² + 5x + 7 | B1 | x² + 6x + 6 | 4A | x² + 7x + 7 | 8B | x² + 8x + 6 | 94 |
| x² + 1x + 5 | AF | x² + 2x + 6 | A8 | x² + 3x + B | 8F | x² + 4x + 7 | DC | x² + 5x + 7 | B7 | x² + 6x + 6 | 4D | x² + 7x + 7 | 8D | x² + 8x + 6 | 9E |
| x² + 1x + 5 | B5 | x² + 2x + 6 | C9 | x² + 3x + B | C6 | x² + 4x + 7 | E8 | x² + 5x + 7 | DB | x² + 6x + 6 | 65 | x² + 7x + 7 | E2 | x² + 8x + 6 | D7 |
| x² + 1x + 5 | BE | x² + 2x + 6 | CE | x² + 3x + B | CD | x² + 4x + 7 | EE | x² + 5x + 7 | DC | x² + 6x + 6 | 6E | x² + 7x + 7 | E9 | x² + 8x + 6 | DC |
| x² + 1x + 8 | 62 | x² + 2x + 8 | 3A | x² + 3x + C | 2B | x² + 4x + 8 | 50 | x² + 5x + 8 | 25 | x² + 6x + 9 | 1A | x² + 7x + 9 | 18 | x² + 8x + 8 | 38 |
| x² + 1x + 8 | 64 | x² + 2x + 8 | 3C | x² + 3x + C | 2D | x² + 4x + 8 | 5B | x² + 5x + 8 | 2F | x² + 6x + 9 | 1C | x² + 7x + 9 | 1F | x² + 8x + 8 | 3F |
| x² + 1x + 8 | 70 | x² + 2x + 8 | 50 | x² + 3x + C | 63 | x² + 4x + 8 | 6B | x² + 5x + 8 | 45 | x² + 6x + 9 | 30 | x² + 7x + 9 | 71 | x² + 8x + 8 | 70 |
| x² + 1x + 8 | 77 | x² + 2x + 8 | 5A | x² + 3x + C | 69 | x² + 4x + 8 | 6C | x² + 5x + 8 | 4E | x² + 6x + 9 | 3A | x² + 7x + 9 | 78 | x² + 8x + 8 | 76 |
| x² + 1x + 8 | A7 | x² + 2x + 8 | A4 | x² + 3x + C | 82 | x² + 4x + 8 | D2 | x² + 5x + 8 | B9 | x² + 6x + 9 | 41 | x² + 7x + 9 | 80 | x² + 8x + 8 | 91 |
| x² + 1x + 8 | AD | x² + 2x + 8 | AF | x² + 3x + C | 85 | x² + 4x + 8 | D8 | x² + 5x + 8 | BF | x² + 6x + 9 | 46 | x² + 7x + 9 | 86 | x² + 8x + 8 | 9B |
| x² + 1x + 8 | B1 | x² + 2x + 8 | C1 | x² + 3x + C | C2 | x² + 4x + 8 | E1 | x² + 5x + 8 | DA | x² + 6x + 9 | 64 | x² + 7x + 9 | E6 | x² + 8x + 8 | D6 |
| x² + 1x + 8 | BA | x² + 2x + 8 | C6 | x² + 3x + C | C9 | x² + 4x + 8 | E7 | x² + 5x + 8 | DD | x² + 6x + 9 | 6F | x² + 7x + 9 | ED | x² + 8x + 8 | DD |
| x² + 1x + 9 | 6B | x² + 2x + B | 39 | x² + 3x + D | 21 | x² + 4x + B | 52 | x² + 5x + 9 | 26 | x² + 6x + A | 11 | x² + 7x + B | 11 | x² + 8x + A | 3A |
| x² + 1x + 9 | 6D | x² + 2x + B | 3F | x² + 3x + D | 27 | x² + 4x + B | 59 | x² + 5x + 9 | 2C | x² + 6x + A | 17 | x² + 7x + B | 16 | x² + 8x + A | 3D |
| x² + 1x + 9 | 72 | x² + 2x + B | 55 | x² + 3x + D | 62 | x² + 4x + B | 62 | x² + 5x + 9 | 43 | x² + 6x + A | 32 | x² + 7x + B | 70 | x² + 8x + A | 79 |
| x² + 1x + 9 | 75 | x² + 2x + B | 5F | x² + 3x + D | 68 | x² + 4x + B | 65 | x² + 5x + 9 | 48 | x² + 6x + A | 38 | x² + 7x + B | 7A | x² + 8x + A | 7F |
| x² + 1x + 9 | A3 | x² + 2x + B | A5 | x² + 3x + D | 8B | x² + 4x + B | D3 | x² + 5x + 9 | B8 | x² + 6x + A | 4B | x² + 7x + B | 8A | x² + 8x + A | 95 |
| x² + 1x + 9 | A9 | x² + 2x + B | AE | x² + 3x + D | 8C | x² + 4x + B | D9 | x² + 5x + 9 | BE | x² + 6x + A | 4C | x² + 7x + B | 8C | x² + 8x + A | 9F |
| x² + 1x + 9 | B2 | x² + 2x + B | CA | x² + 3x + D | C0 | x² + 4x + B | EB | x² + 5x + 9 | D9 | x² + 6x + A | 60 | x² + 7x + B | E4 | x² + 8x + A | D5 |
| x² + 1x + 9 | B9 | x² + 2x + B | CD | x² + 3x + D | CB | x² + 4x + B | ED | x² + 5x + 9 | DE | x² + 6x + A | 6B | x² + 7x + B | EF | x² + 8x + A | DE |
| x² + 1x + E | 68 | x² + 2x + C | 33 | x² + 3x + E | 29 | x² + 4x + D | 55 | x² + 5x + C | 27 | x² + 6x + D | 10 | x² + 7x + D | 10 | x² + 8x + D | 32 |
| x² + 1x + E | 6E | x² + 2x + C | 35 | x² + 3x + E | 3F | x² + 4x + D | 5E | x² + 5x + C | 2D | x² + 6x + D | 16 | x² + 7x + D | 17 | x² + 8x + D | 35 |
| x² + 1x + E | 79 | x² + 2x + C | 54 | x² + 3x + E | 65 | x² + 4x + D | 6A | x² + 5x + C | 41 | x² + 6x + D | 31 | x² + 7x + D | 77 | x² + 8x + D | 7B |
| x² + 1x + E | 7E | x² + 2x + C | 5E | x² + 3x + E | 6F | x² + 4x + D | 6D | x² + 5x + C | 4A | x² + 6x + D | 3B | x² + 7x + D | 7D | x² + 8x + D | 7D |
| x² + 1x + E | A6 | x² + 2x + C | A7 | x² + 3x + E | 8A | x² + 4x + D | D5 | x² + 5x + C | B2 | x² + 6x + D | 48 | x² + 7x + D | 82 | x² + 8x + D | 93 |
| x² + 1x + E | AC | x² + 2x + C | AC | x² + 3x + E | 8D | x² + 4x + D | DF | x² + 5x + C | B4 | x² + 6x + D | 4F | x² + 7x + D | 84 | x² + 8x + D | 99 |
| x² + 1x + E | B3 | x² + 2x + C | C3 | x² + 3x + E | C5 | x² + 4x + D | E9 | x² + 5x + C | D0 | x² + 6x + D | 66 | x² + 7x + D | E1 | x² + 8x + D | D2 |
| x² + 1x + E | B8 | x² + 2x + C | C4 | x² + 3x + E | CE | x² + 4x + D | EF | x² + 5x + C | D7 | x² + 6x + D | 6D | x² + 7x + D | EA | x² + 8x + D | D9 |
| x² + 1x + F | 61 | x² + 2x + F | 30 | x² + 3x + F | 23 | x² + 4x + E | 57 | x² + 5x + D | 24 | x² + 6x + E | 1B | x² + 7x + F | 19 | x² + 8x + F | 30 |
| x² + 1x + F | 67 | x² + 2x + F | 36 | x² + 3x + F | 25 | x² + 4x + E | 5C | x² + 5x + D | 2E | x² + 6x + E | 1D | x² + 7x + F | 1E | x² + 8x + F | 37 |
| x² + 1x + F | 7B | x² + 2x + F | 51 | x² + 3x + F | 64 | x² + 4x + E | 63 | x² + 5x + D | 47 | x² + 6x + E | 33 | x² + 7x + F | 76 | x² + 8x + F | 72 |
| x² + 1x + F | 7C | x² + 2x + F | 5B | x² + 3x + F | 6E | x² + 4x + E | 64 | x² + 5x + D | 4C | x² + 6x + E | 39 | x² + 7x + F | 7C | x² + 8x + F | 74 |
| x² + 1x + F | A2 | x² + 2x + F | A6 | x² + 3x + F | 83 | x² + 4x + E | D4 | x² + 5x + D | B3 | x² + 6x + E | 42 | x² + 7x + F | 88 | x² + 8x + F | 97 |
| x² + 1x + F | A8 | x² + 2x + F | AD | x² + 3x + F | 84 | x² + 4x + E | DE | x² + 5x + D | B5 | x² + 6x + E | 45 | x² + 7x + F | 8E | x² + 8x + F | 9D |
| x² + 1x + F | B0 | x² + 2x + F | C8 | x² + 3x + F | C7 | x² + 4x + E | E3 | x² + 5x + D | D3 | x² + 6x + E | 62 | x² + 7x + F | E3 | x² + 8x + F | D1 |
| x² + 1x + F | BB | x² + 2x + F | CF | x² + 3x + F | CC | x² + 4x + E | E5 | x² + 5x + D | D4 | x² + 6x + E | 69 | x² + 7x + F | E8 | x² + 8x + F | DA |

Ground-Field Poly = x⁴ + x³ + x² + x + 1

| C-F poly | Basis | C-F poly | Basis | C-F poly | Basis | C-F poly | Basis | C-F poly | Basis | C-F poly | Basis | C-F poly | Basis |
|---|---|---|---|---|---|---|---|---|---|---|---|---|---|
| x² + 9x + 4 | 83 | x² + Ax + 1 | 15 | x² + Bx + 1 | 12 | x² + Cx + 4 | 29 | x² + Dx + 2 | 45 | x² + Ex + 2 | 48 | x² + Fx + 1 | 96 |
| x² + 9x + 4 | 89 | x² + Ax + 1 | 1F | x² + Bx + 1 | 19 | x² + Cx + 4 | 2E | x² + Dx + 2 | 4F | x² + Ex + 2 | 4E | x² + Fx + 1 | 9D |
| x² + 9x + 4 | A2 | x² + Ax + 1 | 25 | x² + Bx + 1 | 5B | x² + Cx + 4 | 33 | x² + Dx + 2 | 5A | x² + Ex + 2 | 73 | x² + Fx + 1 | B1 |
| x² + 9x + 4 | A5 | x² + Ax + 1 | 2E | x² + Bx + 1 | 5D | x² + Cx + 4 | 38 | x² + Dx + 2 | 5D | x² + Ex + 2 | 78 | x² + Fx + 1 | BB |
| x² + 9x + 4 | D8 | x² + Ax + 1 | 9A | x² + Bx + 1 | B2 | x² + Cx + 4 | E6 | x² + Dx + 2 | 85 | x² + Ex + 2 | C6 | x² + Fx + 1 | C0 |
| x² + 9x + 4 | DD | x² + Ax + 1 | 9D | x² + Bx + 1 | B5 | x² + Cx + 4 | EC | x² + Dx + 2 | 8E | x² + Ex + 2 | CC | x² + Fx + 1 | C6 |
| x² + 9x + 4 | F2 | x² + Ax + 1 | A9 | x² + Bx + 1 | F3 | x² + Cx + 4 | F8 | x² + Dx + 2 | 99 | x² + Ex + 2 | F9 | x² + Fx + 1 | E8 |
| x² + 9x + 4 | F9 | x² + Ax + 1 | AF | x² + Bx + 1 | F9 | x² + Cx + 4 | FE | x² + Dx + 2 | 9F | x² + Ex + 2 | FE | x² + Fx + 1 | EF |
| x² + 9x + 5 | 84 | x² + Ax + 3 | 12 | x² + Bx + 3 | 16 | x² + Cx + 5 | 21 | x² + Dx + 3 | 47 | x² + Ex + 3 | 4B | x² + Fx + 2 | 91 |
| x² + 9x + 5 | 8E | x² + Ax + 3 | 18 | x² + Bx + 3 | 1D | x² + Cx + 5 | 26 | x² + Dx + 3 | 4D | x² + Ex + 3 | 4D | x² + Fx + 2 | 9A |
| x² + 9x + 5 | A3 | x² + Ax + 3 | 20 | x² + Bx + 3 | 50 | x² + Cx + 5 | 34 | x² + Dx + 3 | 50 | x² + Ex + 3 | 72 | x² + Fx + 2 | B7 |
| x² + 9x + 5 | A4 | x² + Ax + 3 | 2B | x² + Bx + 3 | 56 | x² + Cx + 5 | 3F | x² + Dx + 3 | 57 | x² + Ex + 3 | 79 | x² + Fx + 2 | BD |
| x² + 9x + 5 | D3 | x² + Ax + 3 | 9B | x² + Bx + 3 | B8 | x² + Cx + 5 | E0 | x² + Dx + 3 | 81 | x² + Ex + 3 | C3 | x² + Fx + 2 | C2 |
| x² + 9x + 5 | D5 | x² + Ax + 3 | 9C | x² + Bx + 3 | BF | x² + Cx + 5 | EA | x² + Dx + 3 | 8A | x² + Ex + 3 | C9 | x² + Fx + 2 | C4 |
| x² + 9x + 5 | F7 | x² + Ax + 3 | A1 | x² + Bx + 3 | F1 | x² + Cx + 5 | FA | x² + Dx + 3 | 92 | x² + Ex + 3 | F2 | x² + Fx + 2 | E0 |
| x² + 9x + 5 | FC | x² + Ax + 3 | A7 | x² + Bx + 3 | FB | x² + Cx + 5 | FC | x² + Dx + 3 | 94 | x² + Ex + 3 | F5 | x² + Fx + 2 | E7 |
| x² + 9x + 6 | B0 | x² + Ax + 5 | 16 | x² + Bx + 4 | 15 | x² + Cx + 6 | 22 | x² + Dx + 6 | 42 | x² + Ex + 4 | 43 | x² + Fx + 4 | 90 |
| x² + 9x + 6 | BA | x² + Ax + 5 | 1C | x² + Bx + 4 | 1E | x² + Cx + 6 | 25 | x² + Dx + 6 | 48 | x² + Ex + 4 | 45 | x² + Fx + 4 | 9B |
| x² + 9x + 6 | A1 | x² + Ax + 5 | 23 | x² + Bx + 4 | 59 | x² + Cx + 6 | 32 | x² + Dx + 6 | 58 | x² + Ex + 4 | 77 | x² + Fx + 4 | B2 |
| x² + 9x + 6 | A6 | x² + Ax + 5 | 28 | x² + Bx + 4 | 5F | x² + Cx + 6 | 39 | x² + Dx + 6 | 5C | x² + Ex + 4 | 7C | x² + Fx + 4 | B8 |
| x² + 9x + 6 | DA | x² + Ax + 5 | 99 | x² + Bx + 4 | BA | x² + Cx + 6 | E3 | x² + Dx + 6 | 80 | x² + Ex + 4 | C4 | x² + Fx + 4 | C1 |
| x² + 9x + 6 | DC | x² + Ax + 5 | 9E | x² + Bx + 4 | BD | x² + Cx + 6 | E9 | x² + Dx + 6 | 8B | x² + Ex + 4 | CE | x² + Fx + 4 | C7 |
| x² + 9x + 6 | F4 | x² + Ax + 5 | A8 | x² + Bx + 4 | F5 | x² + Cx + 6 | FB | x² + Dx + 6 | 91 | x² + Ex + 4 | F3 | x² + Fx + 4 | EB |
| x² + 9x + 6 | FF | x² + Ax + 5 | AE | x² + Bx + 4 | FF | x² + Cx + 6 | FD | x² + Dx + 6 | 97 | x² + Ex + 4 | F4 | x² + Fx + 4 | EC |
| x² + 9x + 7 | 87 | x² + Ax + 7 | 11 | x² + Bx + 6 | 11 | x² + Cx + 7 | 2A | x² + Dx + 7 | 40 | x² + Ex + 5 | 40 | x² + Fx + 7 | 97 |
| x² + 9x + 7 | 8D | x² + Ax + 7 | 1B | x² + Bx + 6 | 1A | x² + Cx + 7 | 2D | x² + Dx + 7 | 4A | x² + Ex + 5 | 46 | x² + Fx + 7 | 9C |
| x² + 9x + 7 | A0 | x² + Ax + 7 | 26 | x² + Bx + 6 | 52 | x² + Cx + 7 | 35 | x² + Dx + 7 | 51 | x² + Ex + 5 | 76 | x² + Fx + 7 | B4 |
| x² + 9x + 7 | A7 | x² + Ax + 7 | 2D | x² + Bx + 6 | 54 | x² + Cx + 7 | 3E | x² + Dx + 7 | 56 | x² + Ex + 5 | 7D | x² + Fx + 7 | BE |
| x² + 9x + 7 | D2 | x² + Ax + 7 | 98 | x² + Bx + 6 | B0 | x² + Cx + 7 | E5 | x² + Dx + 7 | 84 | x² + Ex + 5 | C1 | x² + Fx + 7 | C3 |
| x² + 9x + 7 | D4 | x² + Ax + 7 | 9F | x² + Bx + 6 | B7 | x² + Cx + 7 | EF | x² + Dx + 7 | 8F | x² + Ex + 5 | CB | x² + Fx + 7 | C5 |
| x² + 9x + 7 | F1 | x² + Ax + 7 | A0 | x² + Bx + 6 | F7 | x² + Cx + 7 | F9 | x² + Dx + 7 | 9A | x² + Ex + 5 | F8 | x² + Fx + 7 | E3 |
| x² + 9x + 7 | FA | x² + Ax + 7 | A6 | x² + Bx + 6 | FD | x² + Cx + 7 | FF | x² + Dx + 7 | 9C | x² + Ex + 5 | FF | x² + Fx + 7 | E4 |
| x² + 9x + C | 81 | x² + Ax + 8 | 13 | x² + Bx + 9 | 17 | x² + Cx + 8 | 23 | x² + Dx + A | 46 | x² + Ex + A | 42 | x² + Fx + 9 | 95 |
| x² + 9x + C | 8B | x² + Ax + 8 | 19 | x² + Bx + 9 | 1C | x² + Cx + 8 | 24 | x² + Dx + A | 4C | x² + Ex + A | 44 | x² + Fx + 9 | 9E |
| x² + 9x + C | A8 | x² + Ax + 8 | 22 | x² + Bx + 9 | 53 | x² + Cx + 8 | 37 | x² + Dx + A | 59 | x² + Ex + A | 71 | x² + Fx + 9 | B5 |
| x² + 9x + C | AF | x² + Ax + 8 | 29 | x² + Bx + 9 | 55 | x² + Cx + 8 | 3C | x² + Dx + A | 5E | x² + Ex + A | 7A | x² + Fx + 9 | BF |
| x² + 9x + C | D0 | x² + Ax + 8 | 92 | x² + Bx + 9 | B3 | x² + Cx + 8 | E4 | x² + Dx + A | 83 | x² + Ex + A | C7 | x² + Fx + 9 | C9 |
| x² + 9x + C | D6 | x² + Ax + 8 | 95 | x² + Bx + 9 | B4 | x² + Cx + 8 | EE | x² + Dx + A | 88 | x² + Ex + A | CD | x² + Fx + 9 | CF |
| x² + 9x + C | F6 | x² + Ax + 8 | AB | x² + Bx + 9 | F4 | x² + Cx + 8 | F3 | x² + Dx + A | 98 | x² + Ex + A | F0 | x² + Fx + 9 | EA |
| x² + 9x + C | FD | x² + Ax + 8 | AD | x² + Bx + 9 | FE | x² + Cx + 8 | F5 | x² + Dx + A | 9E | x² + Ex + A | F7 | x² + Fx + 9 | ED |
| x² + 9x + D | 86 | x² + Ax + A | 14 | x² + Bx + B | 13 | x² + Cx + 9 | 2B | x² + Dx + B | 44 | x² + Ex + B | 41 | x² + Fx + A | 92 |
| x² + 9x + D | 8C | x² + Ax + A | 1E | x² + Bx + B | 18 | x² + Cx + 9 | 2C | x² + Dx + B | 4E | x² + Ex + B | 47 | x² + Fx + A | 99 |
| x² + 9x + D | A9 | x² + Ax + A | 27 | x² + Bx + B | 58 | x² + Cx + 9 | 30 | x² + Dx + B | 53 | x² + Ex + B | 70 | x² + Fx + A | B3 |
| x² + 9x + D | AE | x² + Ax + A | 2C | x² + Bx + B | 5E | x² + Cx + 9 | 3B | x² + Dx + B | 54 | x² + Ex + B | 7B | x² + Fx + A | B9 |
| x² + 9x + D | D8 | x² + Ax + A | 93 | x² + Bx + B | B9 | x² + Cx + 9 | E2 | x² + Dx + B | 87 | x² + Ex + B | C2 | x² + Fx + A | CB |
| x² + 9x + D | DE | x² + Ax + A | 94 | x² + Bx + B | BE | x² + Cx + 9 | E8 | x² + Dx + B | 8C | x² + Ex + B | C8 | x² + Fx + A | CD |
| x² + 9x + D | F3 | x² + Ax + A | A3 | x² + Bx + B | F6 | x² + Cx + 9 | F1 | x² + Dx + B | 93 | x² + Ex + B | FB | x² + Fx + A | E2 |
| x² + 9x + D | F8 | x² + Ax + A | A5 | x² + Bx + B | FC | x² + Cx + 9 | F7 | x² + Dx + B | 95 | x² + Ex + B | FC | x² + Fx + A | E5 |
| x² + 9x + E | 82 | x² + Ax + C | 10 | x² + Bx + C | 10 | x² + Cx + A | 28 | x² + Dx + E | 41 | x² + Ex + C | 49 | x² + Fx + C | 93 |
| x² + 9x + E | 88 | x² + Ax + C | 1A | x² + Bx + C | 1B | x² + Cx + A | 2F | x² + Dx + E | 4B | x² + Ex + C | 4F | x² + Fx + C | 98 |
| x² + 9x + E | AB | x² + Ax + C | 24 | x² + Bx + C | 51 | x² + Cx + A | 36 | x² + Dx + E | 58 | x² + Ex + C | 75 | x² + Fx + C | B6 |
| x² + 9x + E | AC | x² + Ax + C | 2F | x² + Bx + C | 57 | x² + Cx + A | 3D | x² + Dx + E | 5F | x² + Ex + C | 7E | x² + Fx + C | BC |
| x² + 9x + E | D1 | x² + Ax + C | 91 | x² + Bx + C | BB | x² + Cx + A | E1 | x² + Dx + E | 86 | x² + Ex + C | C5 | x² + Fx + C | C8 |
| x² + 9x + E | D7 | x² + Ax + C | 96 | x² + Bx + C | BC | x² + Cx + A | EB | x² + Dx + E | 8D | x² + Ex + C | CF | x² + Fx + C | CE |
| x² + 9x + E | F0 | x² + Ax + C | AA | x² + Bx + C | F2 | x² + Cx + A | F0 | x² + Dx + E | 90 | x² + Ex + C | FA | x² + Fx + C | E9 |
| x² + 9x + E | FB | x² + Ax + C | AC | x² + Bx + C | F8 | x² + Cx + A | F6 | x² + Dx + E | 96 | x² + Ex + C | FD | x² + Fx + C | EE |
| x² + 9x + F | 85 | x² + Ax + E | 17 | x² + Bx + E | 14 | x² + Cx + B | 20 | x² + Dx + F | 43 | x² + Ex + D | 4A | x² + Fx + F | 94 |
| x² + 9x + F | 8F | x² + Ax + E | 1D | x² + Bx + E | 1F | x² + Cx + B | 27 | x² + Dx + F | 49 | x² + Ex + D | 4C | x² + Fx + F | 9F |
| x² + 9x + F | AA | x² + Ax + E | 21 | x² + Bx + E | 5A | x² + Cx + B | 31 | x² + Dx + F | 52 | x² + Ex + D | 74 | x² + Fx + F | B0 |
| x² + 9x + F | AD | x² + Ax + E | 2A | x² + Bx + E | 5C | x² + Cx + B | 3A | x² + Dx + F | 55 | x² + Ex + D | 7F | x² + Fx + F | BA |
| x² + 9x + F | D9 | x² + Ax + E | 90 | x² + Bx + E | B1 | x² + Cx + B | E7 | x² + Dx + F | 82 | x² + Ex + D | C0 | x² + Fx + F | CA |
| x² + 9x + F | DF | x² + Ax + E | 97 | x² + Bx + E | B6 | x² + Cx + B | ED | x² + Dx + F | 89 | x² + Ex + D | CA | x² + Fx + F | CC |
| x² + 9x + F | F5 | x² + Ax + E | A2 | x² + Bx + E | F0 | x² + Cx + B | F2 | x² + Dx + F | 9B | x² + Ex + D | F1 | x² + Fx + F | E1 |
| x² + 9x + F | FE | x² + Ax + E | A4 | x² + Bx + E | FA | x² + Cx + B | F4 | x² + Dx + F | 9D | x² + Ex + D | F6 | x² + Fx + F | E6 |

The 2880 composite-field polynomials along with their basis element (y=e^{y}) are shown above for ground-field polynomials x⁴+x+1, x⁴+x³+1 and x⁴+x³+x²+x+1. The basis element γ, is used to generate mapping matrix [γ⁷, γ⁵, γ⁴, γ³, y², y, 1] and its inverse matrix. Each of these polynomial pairs, along with the basis was used to automatically generate parameterized register transfer level (RTL) for AES encrypt and AES decrypt rounds as well as RTL for mapping and inverse-mapping hardware to convert operands between GF(2⁸) and GF(2⁴)².

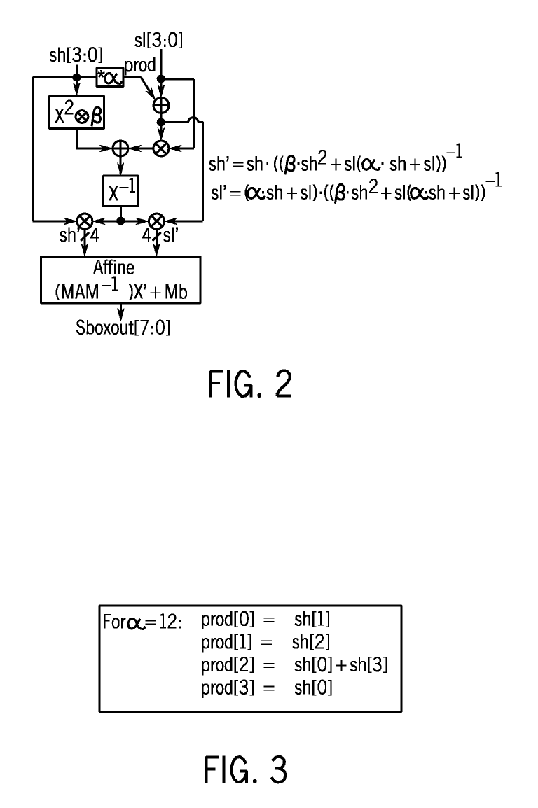

The process was automated to synthesize all 2880 polynomial-pairs and the lowest area solution is obtained. Pairs for the ground-field polynomial of x⁴+x³+1 and composite-field polynomial of x²+Cx+C with Mix Column scaling factor of c7. This design uses α>1 as a choice in the composite-field polynomial. The use of α>1 requires the use of an additional multiplier in the AES S-box as shown in FIG. 2. The overhead for this multiplier may be low, as seen in FIG. 3, where this multiplier can be implemented with one exclusive OR gate for the lowest-area case of a=C.

The design is further optimized by considering three options regarding addition of the affine constant Mb. This constant can be added at the end of the affine transform or can be set to 0xff or 0x00. In the latter two cases, the affine constant is instead added to the RoundKey. The lowest-area solution changes to the case where Mb=0xFF and the new polynomial-pair of x⁴+x³+1 and x²+Cx+C with mixcol scaling factor of c2, resulting in a further reduction in area.

The lowest-area AES decrypt hardware is obtained with the ground-field polynomial of x⁴+x³+1 and composite-field polynomial of x²+Cx+2, with Mix Column scaling factor of 13. We further explore the decrypt design space by synthesizing the design for the three choices of inverse-affince constant MAinvb (MAinvb=MAinvb, MAinvb=0 and MAinvb=1). This yields the optimal decrypt polynomial pair of x⁴+x³+1 and x²+6x+4, with MixColumn scaling factor of 13 and a total area of 6060 sq.um, resulting in overall area improvement. Thus we have encrypt and decrypt hardware with two separate polynomials, each optimized separately to minimize area.

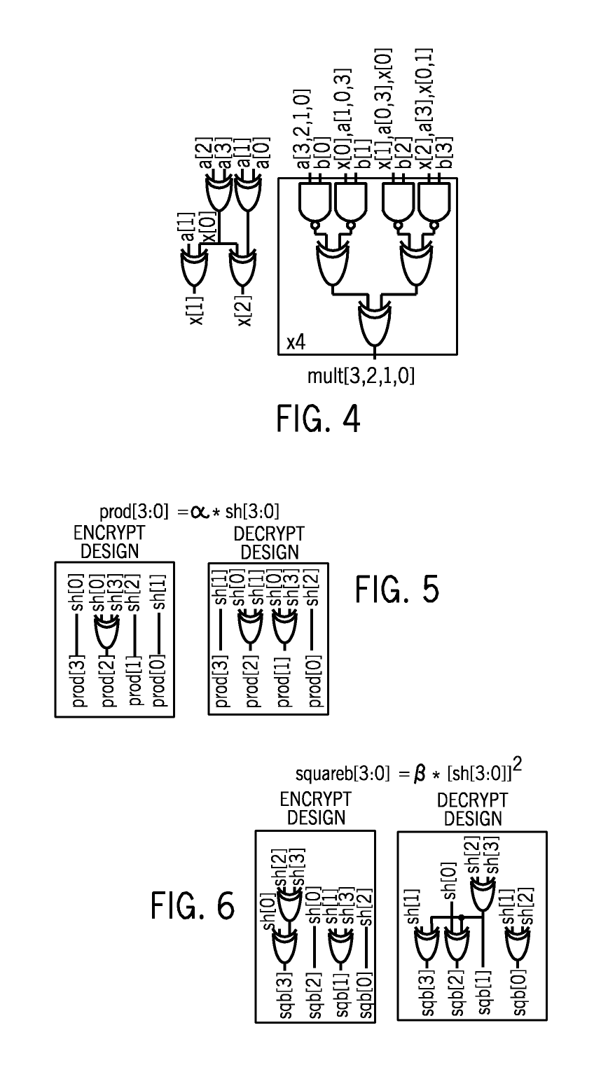

Since both encrypt and decrypt hardware are optimal for the same ground-field of x⁴+x³+1, the multiplier and inverse calculation in GF(2⁴) will use identical designs, as shown in FIG. 4, since the choice of composite-field polynomial has no impact on these blocks. However, the sh*α and the square*β block in the S-box shown in FIG. 2 use separate designs for encrypt and decrypt, since the designs of these blocks (FIGS. 5 and 6) depend on the composite-field polynomial and hence depend on the choice of α and β.

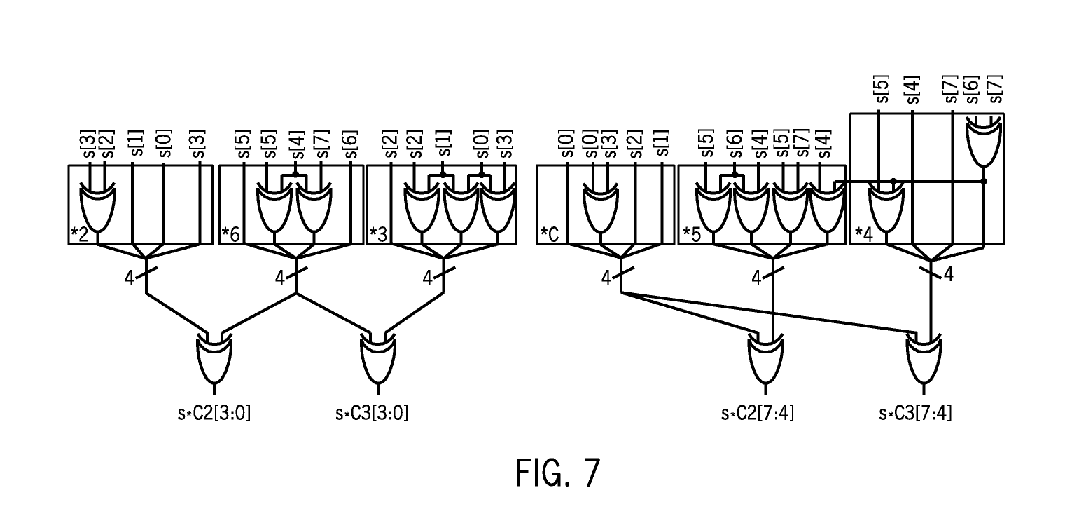

The use of separate composite-field polynomials for encrypt and decrypt also result in unique mix column/inverse-mix column blocks for encrypt and decrypt. The use of MixColumn scaling factors of 0xc2 and 0xc3 during encrypt result in simple multiplication factors of *2, *6, *3, *C, *4 and *5 which is implemented using 1, 2, 3, 1, 4 and 2 exclusive OR gate respectively (FIG. 7). This results in a compact 28 exclusive OR implementation for each byte of the MixColumn block (FIG. 7).

Similarly, the inverse-mix column block for decrypt is designed by computing the scaling factors *2, *3, *4, *5, *6, *7, *B and *E. Thus, we have an encrypt block with single cycle latency and a decrypt block that operates at the same frequency and latency. We also leverage the eight percent (8%) lower area of the encrypt block to use it for the performance-critical read operations and instead use the larger decrypt block during memory-writes.

We use the compact encrypt block for memory-reads which are more performance-critical compared to memory-writes. The presence of more read ports than write ports justifies the use of the lower-area encrypt design for read operations.

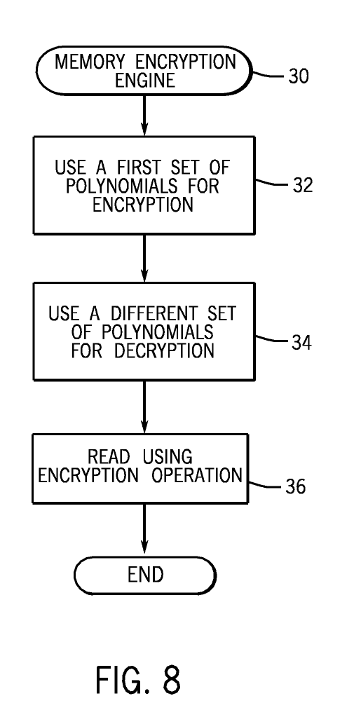

Referring to FIG. 8, in accordance with some embodiments, a memory encryption engine sequence 30 may be implemented in software, firmware, and/or hardware. In software and firmware embodiments, it may be implemented by computer executed instructions stored in a non-transitory computer readable medium such as a magnetic, optic or semiconductor storage.

Sequence 30 begins by using the first set of polynomials for encryption as indicated in block 32. A different set of polynomials may be used for decryption as indicated in block 34. In some embodiments encryption operations may be used for reading as indicated in block 36.

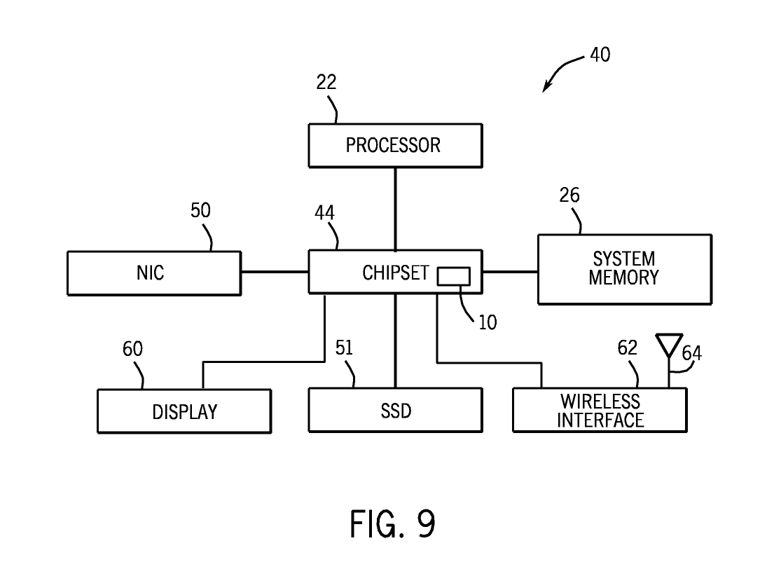

Referring to FIG. 9, a system 40 may be a portable computing device, such as a laptop computer, a tablet computer, or a cellular telephone, or it may be a personal computer, to mention a few examples. System 40 may include a processor or core 22 coupled to a chipset 44. The chipset 44 may be in turn coupled to a system memory 26 and the solid state drive 51. A network interface card (“NIC”) 50 may be coupled the chipset 44. The chipset, in one embodiment may include the memory encryption engine 10.

Also coupled to the chipset 44 is a wireless interface 62 having an antenna 64. The wireless interface may be a cellular interface such as a Third Generation Partnership Project (3GPP) or Long Term Evolution (LTE) cellular interface. Also coupled to the chipset 44 is a display 60. In one embodiment the display 60 may be a touch screen.

The processor may be any processor or controller. In one embodiment the processor 22 may be an application processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
using a first set of polynomials in a memory encryption engine for encryption and;
using a different set of polynomials in said engine for decryption.

2. The method of claim 1 including using encryption operations for reading.

3. The method of claim 1 including using Advanced Encryption Standard.

4. The method of claim 1 including selecting polynomials to optimize area usage.

5. The method of claim 1 including selecting polynomials to optimize power consumption.

6. The method of claim 1 including using Galois polynomials

7. The method of claim 1 including using irreducible polynomials.

8. The method of claim 1 including locating a primitive element that is both a generator and a root of a composite field.

9. The method of claim 8 including ensuring that an element exists in the field such that none of the powers of the element is one.

10. A non-transitory computer readable medium storing instructions to enable a processor to:
use a first set of polynomials for encryption and;
use a different set of polynomials for decryption.

11. The medium of claim 10 further storing instructions to use encryption operations for reading.

12. The medium of claim 10 further storing instructions to use Advanced Encryption Standard.

13. The medium of claim 10 further storing instructions to select polynomials to optimize area usage.

14. The medium of claim 10 further storing instructions to select polynomials to optimize power consumption.

15. The medium of claim 10 further storing instructions to use Galois polynomials.

16. The medium of claim 10 further storing instructions to use irreducible polynomials.

17. The medium of claim 10 further storing instructions to locate a primitive element that is both a generator and a root of a composite field.

18. The medium of claim 17 further storing instructions to ensure that an element exists in the field such that none of the powers of the element is one.

19. An apparatus comprising:
a memory write path to use a first set of polynomials; and
a memory read path to use a different set of polynomials.

20. The apparatus of claim 19 said apparatus to use encryption operations for reading.

21. The apparatus of claim 19 said apparatus to use Advanced Encryption Standard.

22. The apparatus of claim 19 said apparatus to select polynomials to optimize area usage.

23. The apparatus of claim 19 said apparatus to select polynomials to optimize power consumption.

24. The apparatus of claim 19 said apparatus to use Galois polynomials.

25. The apparatus of claim 19 said apparatus to use irreducible polynomials.

26. The apparatus of claim 19 said apparatus to locate a primitive element that is both a generator and a root of a composite field.

27. The apparatus of claim 26 said apparatus to ensure that an element exists in the field such that none of the powers of the element is one.

28. A system comprising:
a core;
a memory coupled to the core;
a memory encryption engine coupled to said core, said engine to use in first set of polynomials for encryption and a different set of polynomials for decryption; and
a network interface card coupled to said core.

29. The system of claim 28, said engine to use encryption operations for reading.

30. The system of claim 19, said engine to use irreducible polynomials.
